(19) United States
(12) Patent Application Publication
(10) Pub. No.: US 2013/0134803 A1
(43) Pub. Date: May 30, 2013

(54) ELECTROMECHANICAL MOTOR

(71) Applicant: Ernst Goepel, Gauting (DE)

(72) Inventor: Ernst Goepel, Gauting (DE)

(73) Assignee: Andreas KAPPEL, Brunnthal (DE)

(21) Appl. No.: 13/582,787

(22) PCT Filed: Mar. 7, 2011
(86) PCT No.: PCT/EP2011/001134

§ 371 Date: Nov. 15, 2012

(30) Foreign Application Priority Data
Mar. 5, 2010 (DE) 10 2010 010 389.6

(51) Int. Cl. H02K 7/07

(52) U.S. Cl. CPC H02K 7/07
USPC 310/20

(57) ABSTRACT

The present invention relates to an electromechanical motor, comprising a rotor, which is rotatable about an axis of rotation, at least one drive element, which can be displaced so as to revolve about the axis of rotation such that the rotor is rotatable by displacement of the drive element, at least two actuators, each with a first effective element, with which a force acting in one effective direction can be exerted onto a second effective element, wherein the first and the corresponding second effective element are not interconnected, and wherein the drive element can be displaced for rotation of the rotor as a result of the effect of the force of the at least two actuators.

The present invention relates to an electromechanical motor, in particular an easily controllable silent and overload-proof electric motor with high torque density, driven by electromagnetic fields.

Stepper motors, as described for example in EP 1087502 B1, are known from, the prior art. Motors of this type have a range of parasitic effects, caused by their operating principle. These include, in particular, the motor noise, which is produced by the forces exerted by the electromagnetic alternating fields onto the mechanical components. In addition, stepper motors of this type have cogging torque, even with a small pitch of the pole piece of the stator and rotor, which likewise lead, to the production of noise and which further limit positioning accuracy. The development of noise can indeed be reduced by an uneven pitch of the pole piece at the stator and rotor, as described in EP 1087502 B1, but due to the finite number of pole pairs that can be housed in the available installation space, cannot be completely prevented.

Electronically commutated and brush-commutated DC motors are widespread. They can be produced in. a cost effective manner and enable high power densities. The construction of motors of this type is described for example in EP 1324465 B1, EP 0670621 B1 and EP 0901710 B1. The high noise emissions, the low torque, and the limited dynamic behaviour are bothersome in these motors. Even with minimal unbalance, the high operating speeds, typically of 3,000 rpm to 16,000 rpm and the high rotor moment of inertia lead to vibrations and bothersome acoustic emissions. In addition, the dynamic behaviour of such motors is unsatisfactory, since the rotational, energy stored in the rapidly rotating rotor first has to be dispelled when the direction of rotation is commutated.

Due to the low torques, in the majority of cases it is necessary to combine these motors with multi-stage gear systems. Hereby the overall efficiency typically decreases to 50% with a 5-stage spur gearing or planetary gearing, wherein the noise emissions and the gear play increase with each gear stage.

Motors that convert the linear movements of solid-state actuators, preferably piezo actuators, into rotary motion are known from U.S. Pat. No. 5,079,471 A and EP 1098429 B1. These motors allow a very quiet and dynamic operation, since the drive elements are moved in a purely oscillatory manner and, in contrast to electric motors, only a small amount of energy is stored in the system. A disadvantage is the low level of operational stability of these drives. Due to the low useable stroke of the piezo actuators of approximately 10 μm to 100 μm, the motor components have to be manufactured and assembled with a high level of precision. To ensure the function of these piezomotors, the exact position of the individual motor components has to be ensured both over the service life and over a temperature range. Since even slight fluctuations in ambient temperature or the inherent heating of the motor during operation as a result of the thermal expansion of the motor components and of the solid-state actuators lead to misalignment of the motors, these motors can only be operated within a narrowly defined temperature range.

The object of the present invention is to provide an electric motor that overcomes the above-described problems of the prior art and preferably has low noise generation, high torque density and improved operational stability compared to the prior art.

This object is achieved by the electromechanical motor according to Claim 1. Advantageous embodiments of the electromechanical motor are provided by the dependent claims.

In accordance with the invention, an electromechanical motor or electric motor is provided, which has a rotor, which is rotatable about an axis of rotation. The electromechanical motor also has at least one drive element, which can be displaced so as to revolve about the axis of rotation such that the rotor is rotatable by displacement of the drive element. The drive element is normally displaced in a plane perpendicular to the axis of rotation. In this case, “displacement” means movement of the drive element, wherein the drive element experiences a translation. Its orientation may remain substantially unchanged in some embodiments of the invention, such that the drive element does not rotate. In this case, the axes of a coordinate system that is fixed with respect to the drive element therefore enclose substantially the same angle in all phases of the displacement with the axes of a coordinate system that is fixed with respect to a motor housing for example.

In other embodiments however, the drive element may also rotate in addition to the displacement thereof.

This is particularly so in any embodiments in which the drive element is connected to the rotor in a torsionally rigid manner or is part of the rotor.

In accordance with the invention, the at least one drive element is displaced by electromagnetic actuators and/or electrostatic actuators.

For example, the drive element, by means of which the rotor can be rotated, can be displaced by at least two electromagnetic actuators. In electromagnetic actuators of this type, a magnetic force is exerted from, a first effective element onto a second effective element. If one effective element is then connected fixedly to the drive element and the other effective element is fixed with respect to the axis of rotation or the housing of the motor for example, a force can thus be exerted onto the drive element by means of this electromagnetic actuator, as a result of which said drive element can be displaced. For a given actuator, any direction in which the magnetic force acts between the effective elements is to be considered as an effective direction. It is irrelevant whether the effective direction is defined from the first to the second effective element or from the second to the first effective element; the effective direction should merely be determined uniformly within a given electromechanical motor. For all actuators of a given electromechanical motor, the effective direction thus points from, the first to the second effective element or from the second to the first effective element. It is possible for a plurality of effective elements to act on a common, other effective element. For example, a multiplicity of electromagnets may thus act as first effective elements on a common, second effective element, which may be a ring-shaped element for example, which is connected fixedly to the drive element, is part of the drive element or is the drive element itself. In this case, a plurality of electromagnets may particularly advantageously be arranged side by side with alternately opposed polarity, such that the magnetic field of one of the electromagnets, in the outer region thereof, penetrates the core of the adjacent electromagnet so that, in the cores of the magnets, the magnetic fields of three adjacent electromagnets are superposed with an intensifying effect.

The drive element, by means of which the rotor can be rotated, can also be displaced by electrostatic actuators. In actuators of this type, a force is exerted from a first effective element onto a second effective element when an electric voltage is applied. Electrodes or comb-like electrode structures (comb-structures) are used as effective elements. If one effective element is then connected fixedly to the drive element and the other effective element is fixed with respect to the axis of rotation or the housing of the motor for example, a force can thus be exerted onto the drive element, by means of this electrostatic actuator, as a result of which said drive element can be displaced. To increase the electrostatic force, electrostatic actuators of this type may have a multiplicity of electrodes.

In accordance with the invention, the effective elements of a given actuator are not interconnected and preferably also do not contact one another. The effective elements may thus act on one another either by means of magnetic and/or electrostatic forces.

In accordance with the invention, a first advantageous embodiment of the electromechanical motor also has at least one torque support, which prevents rotation of the drive element. A torque support is thus a preferably mechanical component, which withstands or counterbalances any torque acting on the drive element. In particular, torques acting about the axis of rotation can thus be braced or counterbalanced.

In accordance with the invention, in a further advantageous embodiment of the electromechanical motor, the drive element is connected in a torsionally rigid or rotationally engaged manner to the rotor, or is part of the rotor or is the rotor itself. This drive element, which can also be referred to as a drive rotor, can be connected to the motor shaft via at least one torsionally rigid and shear-compliant mechanical element, which can be referred to as a torque support or shaft coupling. The shaft coupling can thus transfer the rotation of the wobbling rotating drive element onto the motor shaft, but at the same time the displacement of the drive element is only opposed by a low level of mechanical resistance. An advantageous toothing of the drive rotor can roll into a toothing of the motor housing with this design.

In a further advantageous embodiment of the electromechanical motor according to the invention, the rotor is formed as a parallel guided wobble plate, which is connected fixedly to the motor shaft. The drive element can be connected fixedly to the rotor, whereby the rotational movement of the rotor transfers directly onto the motor shaft. In this case, the rotational movement thus superposes the displacement of the drive element (wobble plate).

In a preferred embodiment of the invention, the drive element surrounds the rotor or the rotor surrounds the drive element. In this case, the drive element and the rotor can be of circular or elliptical shape. If the rotor surrounds the drive element, the rotor can thus be annular, wherein the drive element is located inside the ring. If the drive element surrounds the rotor, the drive element can thus be annular and the rotor can be located inside the drive element. In this case, it is assumed that the rotor and drive element surround one another at least in the plane in which the drive element is displaced. For example, the rotor and drive element may also extend in this plane in a substantially planar manner.

The rotor and drive element preferably each have a toothing comprising a multiplicity of teeth, via which they engage in one another in regions. A force can thus be transferred particularly effectively from the drive element to the rotor. If the drive element and rotor are elliptical or circular, the respective outwardly arranged element may have the toothing at its inner periphery, and the inwardly arranged element may have the toothing at the outer periphery. The lengths of the peripheries that comprise the toothing are different, such that the inner toothing has a smaller periphery than the outer toothing. Since the drive element is displaced about the axis of rotation, the toothings only engage in one another where the distance between the drive element and the rotor is sufficiently small. Since the drive element is displaced about the axis of rotation, this region of engagement of the toothings revolves in the direction of the displacement about the axis of rotation.

In a further embodiment, the rotor and drive element are connected fixedly or are identically and can be referred to as a drive rotor. The drive rotor can roll into a toothing of the motor housing in this instance. In this case too, the drive rotor and the motor housing preferably each have a toothing comprising a multiplicity of teeth, via which they engage in one another in regions. The toothings of the drive rotor and of the motor housing can be designed in the form of inwardly toothed rings or in the form of outwardly toothed shafts.

In an advantageous embodiment of the invention, the inner toothing has fewer teeth than the outer toothing.

The actuators can be formed in many various ways. They always act electromagnetically, which means that the magnetic force is produced by a flow of current. At least one of the effective elements will thus normally have a coil, by means of which a magnetic field can be generated, which acts on the other effective element. The other effective element may therefore be a magnetic or magnetisable element, in particular a ferromagnetic element.

As described, the effective elements are not interconnected in accordance with the invention. There is therefore preferably always a gap between the effective elements, of which the width varies over the course of the displacement of the drive element. So as to obtain the greatest force possible, it is preferable however if the gap is <2 mm wide at the minimal distance between the effective elements, preferably <1 mm wide, and more preferably ≦0.5 mm wide. A “gap” is understood to mean the area that extends between the mutually opposed surfaces of the effective elements, irrespective of the geometry of the effective elements. If this distance is not equal at all points of the surfaces, the above-mentioned values thus relate to the minimal distance.

Each drive element is displaced by at least two actuators. For a high torque of the motor according to the invention and for smooth rotation, it is preferable however if more than two actuators are provided. These are then preferably arranged around the drive element at equal angular distances. The angle is measured in the plane in which the drive element is displaced.

To displace the drive element, an alternating current can then be applied to the actuators, said alternating current being phase-shifted for the different actuators such that the actuators generate said magnetic force revolving in succession and the drive element is thus displaced in a revolving manner.

In an advantageous embodiment, a plurality of actuators may also act in parallel at the same time. The force of the displacement of the drive element, and therefore the torque of the motor, can thus be increased. Two or more actuators having identical effective directions with respect to the axis of rotation or the midpoint of the drive element can be arranged opposite one another for this purpose. A plurality of effective elements of a first type can also act on a common effective element of the other type, however. For example, a plurality of electromagnets may thus act on a common magnetisable or magnetic effective element.

In advantageous embodiments of the electric motor according to the invention, said motor has a torque support. This is of particular significance, in particular when the drive element for rotating the rotor is merely displaced, but is not rotated. The torque support preferably supports the drive element in a shear-compliant and torsionally rigid manner. The drive element is thus substantially freely displaceable in the bearing of the torque support, but is substantially non-rotatable.

In one embodiment of the invention, such a torque support may have at least one hose-shaped bellows for example. Such a bellows has two edges, which define it. It is thus arranged fixedly on the drive element by one of these edges and is fixed in relation to the axis of rotation or the motor housing via the other edge. Alternatively, at least one solid state hinge arranged between the drive element and the motor housing for example can also be used as a torque support and is arranged fixedly on the drive element on the one hand, and on the other hand is fixed in relation to the axis of rotation or the motor housing. Springs that are arranged fixedly on the drive element via one end and are fixed via the other end with respect to the axis of rotation or the motor housing can also serve as a. torque support. In an advantageous embodiment of the invention, two springs can be arranged opposite with respect to two actuators with their effective directions at right angles to one another, wherein the spring axes are particularly preferably oriented, parallel to the effective direction of the corresponding actuator arranged opposite.

In a particularly preferred embodiment, the springs can be designed, as slotted spring metal, sheets, which extend in a planar manner in the plane in which the drive element is displaced.

In a further embodiment, of the invention, the torque support may have two arms, which each have bars interconnected via a hinge. These bars may then be arranged substantially at right angles, wherein one end of one bar is connected fixedly to the drive element and the other end of the other bar is fixed with respect to the axis of rotation or the motor housing. The two hinges can then be braced together via a strut of high tensile and compressive strength, such that the distance between the hinges is fixed.

In a further possible embodiment of the invention, the torque support may be formed by means of at least two, three or more bolts that are fixed in relation to the axis of rotation or in relation to the motor housing. These bolts engage in recesses in the drive element and are designed and arranged such that they enable a displacement of the drive element, but substantially prevent rotation. To this end, the bolts may dip into a sliding block guide arranged in the recess in the drive element, said sliding block guide having a displacement element. This displacement element has an opening that extends lengthwise in a first direction and into which the bolt dips so that the bolt is displaceable in this element in this direction. The displaceable element is in turn arranged in a recess in the drive element, in which it is displaceable in a direction perpendicular to the first direction.

In addition, it is also possible for each of the bolts to engage in a respective eye of an eccentric tappet, which is arranged in a recess in the drive element. In this case, the eccentric tappet has an eccentric located recess, into which the aforesaid, bolt dips. The eccentric tappet is rotatable about, its midpoint in the recess in the drive element.

In a further advantageous embodiment of the invention, two or more drive elements can be provided, which extend in mutually parallel planes and together drive a rotor. The drive elements are preferably displaceable by their own actuators and are particularly preferably displaced such that the points of the smallest distance between the corresponding drive element and the rotor are distanced from one another about the axis of rotation by an angle of 360° divided, by the number of drive elements. These points of minimal distance thus surround the rotor at equal angular distances.

In a particularly preferred embodiment, the electromechanical motor according to the invention has the following features:
a rotatably mounted rotor, preferably with a toothing,
a motor shaft connected in a rotationally engaged manner to the rotor,
at least one toothed drive ring, which, can be fitted on the rotor, as a drive element,
a structure, referred to hereinafter as a torque support, which is fastened between the drive ring and a motor housing, is torsionally rigid with respect to rotation of the drive ring about the motor shaft axis, but is shear-compliant with respect to transverse displacement of the drive ring in the plane perpendicular to the motor shaft axis,
at least two electromagnetic actuators, each with effective directions lying in the plane of the motor shaft axis, but not parallel to one another, wherein each electromagnetic actuator has two spatially separated effective elements, one of which is fastened to the drive ring, is part thereof or is the drive ring itself, and the other of which is connected to the motor housing, at least one of the two effective elements of each electromagnetic drive element being electrically controllable,
so that the drive ring can be excited by electromagnetic forces between the respective effective elements of the electromagnetic actuators so as to be displaced in the plane perpendicular to the motor shaft axis, in such a way that the rotor roils with a positive fit over the drive ring and the motor shaft is rotated.

The present invention provides an electric motor that is characterised by a high torque density, a high level of operational stability, a low generation of noise, and a cost-effective production. This is achieved in particular by the advantageous measures described hereinafter.

A high level of operational stability results from the transfer of purely magnetic forces between the effective elements of each of the electromagnetic actuators.

Since the motor according to the invention, with the exception of the comparatively low-mass and slowly rotating rotor and the motor shaft connected thereto, preferably has no further rotating components, the energy stored in the drive can be kept low. This results in good dynamic behaviour. At the same time, there is also no need for an electromechanical commutator. Since the effective elements of the electromagnetic actuators are connected, fixedly to the motor housing and to the drive element, and since the drive element merely performs cyclical, circular displacement movements of low amplitude, current can be supplied via fixed or flexible electrical connections.

All known designs of electromagnets are suitable electromagnetic actuators of the motor according to the invention and are referred to as “attracting”, “repelling” and “attracting and repelling” in terms of design. Examples include: electromagnets, pot magnets, voice coils, linear magnets, horseshoe magnets, lifting magnets, magnet poles, etc. The omission of an electromechanical commutator and the use of electromagnets enable cost-effective production.

A torque support preferably attached between the drive element and the motor housing is used for shear-compliant, yet torsionally rigid mechanical mounting of the drive ring. External load torques acting on the motor shaft can be braced at the motor housing via the torque support, whereby the motor according to the invention is able to generate torque. The torque support is preferably shear-compliant in the plane of movement of the drive ring extending perpendicular to the motor shaft axis, such that the displacement of the drive element excited by the electromagnetic actuators is opposed by minimal mechanical resistance. Elements that perform the function of the described torque support include, for example, bellows made of metal, metal alloys, plastic, GFRP, CFRP or ceramics, or kinematic structures having solid state hinges.

In another preferred embodiment, one of the toothings may be fixed and connected to the motor housing. The element referred to as a shaft coupling can be fastened in this case between the drive element and the motor shaft. The rotation of the drive element is transferred directly to the motor shaft via the shaft coupling, for example formed as a bellows. The bellows has a high level of torsional rigidity, but is mechanically compliant to displacement in the plane perpendicular to its longitudinal axis. The displacement of the drive element in the effective plane of the actuators is thus only opposed by a low level of mechanical resistance.

A distinction can therefore be made between at least two advantageous designs:

### Design A.)

Variants with at least one non-rotational drive element, to which end said drive element is fastened in a rotational rigid manner on the motor housing via a torque support.

### Design B.)

Variants with at least one rotating drive element, to which end said drive element is connected to the motor shaft either via a torsionally rigid and shear-compliant mechanical element (shaft coupling), for example a bellows, or can move in a freely rotating and wobbling manner in the motor housing as a result of parallel guides. Since, in this design, the rotor and drive element or drive ring are connected fixedly or are identical, this element can be referred to as a drive rotor.

All exemplary embodiments with a non-rotational drive element of design A.) can be transferred to exemplary embodiments with a rotating drive element of design B.). A detailed presentation and explanation therefore will not be provided for the sake of clarity, and only some exemplary embodiments will be shown.

Preferred electromagnetic actuators for high-torque motors according to the invention are electric pot magnets, since these are able to exert very high forces of up to a few 1000 N on ferromagnetic materials with air gap widths <1 mm, as well as voice coils, and magnet poles arranged side by side.

An increase in motor power can be achieved by attaching a multiplicity of the above electromagnetic actuators to the drive element, wherein these can be positioned both inside and outside the drive ring or drive element. A maximum number of actuators is also advantageous in terms of a maximum uniformity of speed of the motor shaft.

For a number of N actuators, of which the effective directions are directed radially with respect to the motor shaft axis, the following relationship is true for the preferred angular positions α of the actuators or the effective directions thereof over the periphery of the drive ring:

N=2→α=90°

N>2→α=360°/N

The motor according to the invention is preferably actuated electrically by phase-shifted sinusoidal current feed of the electromagnetic drive elements.

The drive element is exited to shift in a circular manner as a result of the above-described electrical actuation of the electromagnetic actuators.

Since, with, design A.), there is positive contact between the drive element and the rotor in each phase of the displacement, the rotor can roll off in the drive element, whereby the rotor and the motor shaft connected thereto in a rotationally engaged manner can be rotated.

Since, with design B.), there is positive contact between the drive rotor and the toothing of the motor housing in each phase of the displacement, the drive rotor or the drive element can roil off in the toothing of the motor housing, whereby the drive rotor and the motor shaft connected thereto in a torsionally rigid, yet shear-compliant manner can be rotated.

The function of the electromechanical motor according to the invention is not limited to the above-described exemplary angular positions of the drive elements however, since the effective direction of individual drive elements does not necessarily have to be directed toward the axis of rotation of the motor shaft.

The positive kinematics forming the basis of the motor according to the invention can convert circular displacement of the drive ring into a high-transmission rotation of the motor shaft. With uniform rotation of the rotor, each point of the drive ring passes cyclically over a circular trajectory. The inner transmission ratio T of the motor is given in this case by the number of cyclical trajectories that the drive ring or the drive element has to pass through for an angular rotation of the rotor of 360°. The following may then be true for the inner transmission ratio T of the motor according to the invention:

T=(m−n)/n where m≠n

m: number of teeth of the drive ring

n: number of teeth of the rotor

If m>n, the drive ring surrounds the rotor, wherein the drive ring may have an inner toothing and the rotor may have an outer toothing.

If m<n, the rotor surrounds the drive ring, wherein the preferably bell-shaped rotor may have an inner toothing and the drive ring may have an outer toothing.

With fine toothings or micro-toothings of the drive ring and rotor with a high number of teeth and a small difference in the number of teeth, a very high inner transmission ratio T can be achieved, in a stage, as is otherwise only possible with multi-stage gearing systems according to the prior art. Due to the fine toothings or micro-toothings, the motor is practically free of play and avoids the high gear friction losses of multi-stage gearing systems as a result of the single-stage reduction ratio.

A particularly high contact ratio, that is to say the number of teeth engaged at the same time, and a maximum transmission ratio can be achieved by a design in which the drive ring and the rotor have a difference in the number of teeth of 1. Typical transmission ratios of toothing pairings of this type may be up to one to a few thousand.

Due to the possible high inner transmission of the motor according to the invention, said motor can generate high torques, and an external gearing system, with its known disadvantages, can be omitted completely. In this case, the rotational speed of the motor shaft can be from zero up to a few 100 revolutions per minute. It is proportional to the electric control frequency f [Hz] of the electromagnetic actuators and can therefore be controlled easily. In particular, the motor shaft can be positioned and held in any angular position, and the direction of rotation can be commutated easily by the phase relation of the electric control signals of the drive elements. For a motor with the inner transmission ratio T [−], the following is true with an electric control frequency f [Hz] for the rotational frequency Ω [Hz] of the motor shaft:

Ω=f·T [Hz]

For example, a control frequency of f=100 Hz with an inner transmission ratio of T= 1/400 gives a rotational frequency of the motor shaft of Ω=0.25 [Hz]. The high inner transmission of the motor according to the invention, in conjunction with powerful electromagnetic actuators, enables gearless motors with high torque and, due to the single-stage transmission, high electromechanical efficiencies.

It is particularly advantageous in all embodiments if the toothings are designed such that their difference in diameter b corresponds to the tooth height. Since the teeth of the rotor and drive element lie exactly opposite in the region opposite the engagement region, the toothing cannot be disengaged. It therefore has self-guiding properties. A sinusoidal tooth profile is furthermore advantageous for the design of the toothing in all embodiments of the invention. In conjunction with a small difference in the number of teeth, ideally of 1, a greater number of teeth are thus always engaged. Due to the high degree of overlap between the toothings of the rotor and drive ring, a favourable load distribution and a high robustness of the toothings with respect to overload are achieved.

Due to the load-proportional twist of the drive element relative to the motor housing and therefore of the first effective elements relative to the second effective elements, the inductances of the electromagnetic actuators change according to the load torque, in particular proportionally thereto. The change of the inductances of the actuators can advantageously be evaluated electronically and used to detect the torque. The load acting on the rotor can thus be established directly at any time.

Due to the positive rolling of the rotor over the drive element, wherein both elements are in constant contact, the generation of noise and the level of wear are also low.

In accordance with the prior art, comb-like electrode structures engaging in one another, referred to as comb drives, are particularly suitable as electrostatic actuators. By applying an electric voltage between the at least two individual electrodes separated electrically from one another by a gap, an electrostatic force acts between the electrodes, the magnitude of said force being controllable by the amplitude of the applied electric voltage. Comb structures of this type can be produced by large scale batch fabrication cost effectively and to great advantage predominantly as micromechatronic components in silicon by means of photolithographic structuring and wet-etching or dry-etching methods. The force acting on the drive element can be suitably increased by mechanically interconnecting a multiplicity of individual comb structures.

The mechanical motor according to the invention will be explained hereinafter by way of example on the basis of some figures. Like reference signs correspond to like or similar elements. In accordance with the invention, the features shown in the examples can also be implemented independently of the specific example.

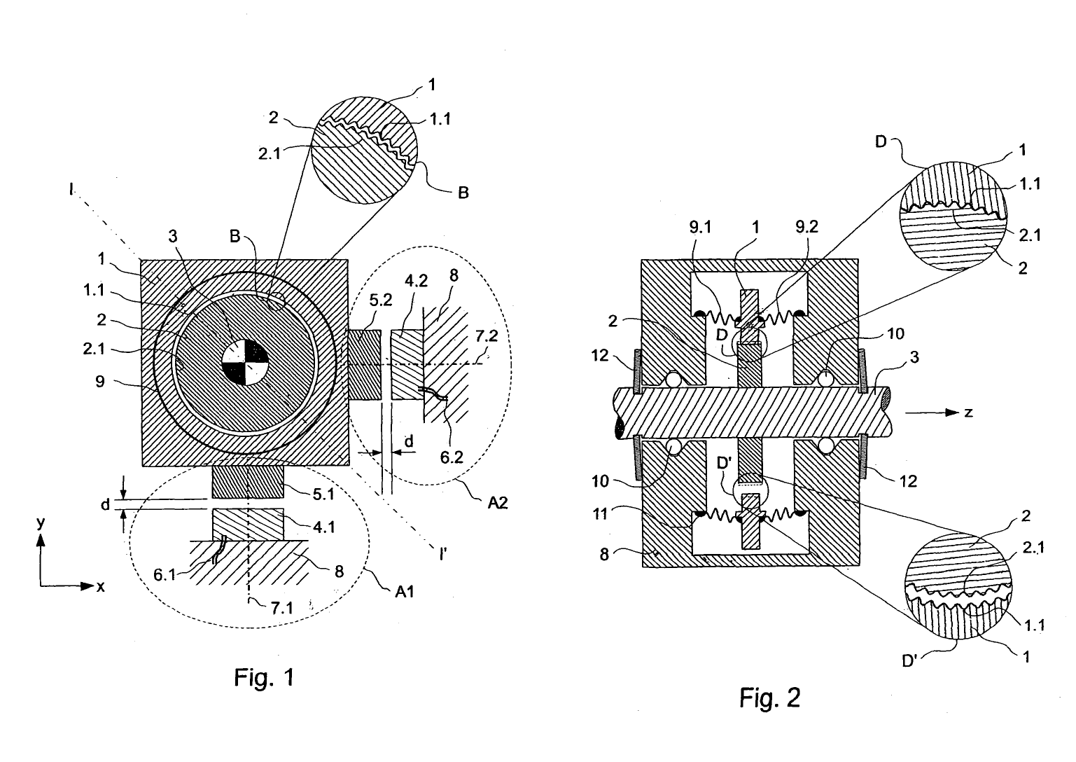

FIG. 1 shows a sectional plan view of a motor according to the invention with an outwardly arranged drive ring, rotor, motor shaft, torque support and two electromagnetic actuators arranged at an angle of 90 degrees to one another.

FIG. 2 shows a sectional illustration of the motor illustrated in FIG. 1 along the line I-I′ in FIG. 1.

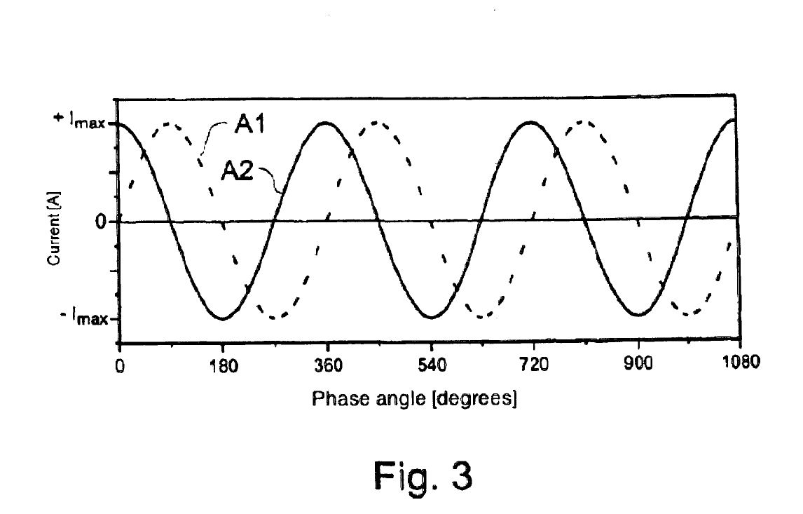

FIG. 3 shows an actuation pattern suitable for operation of the motor according to the invention.

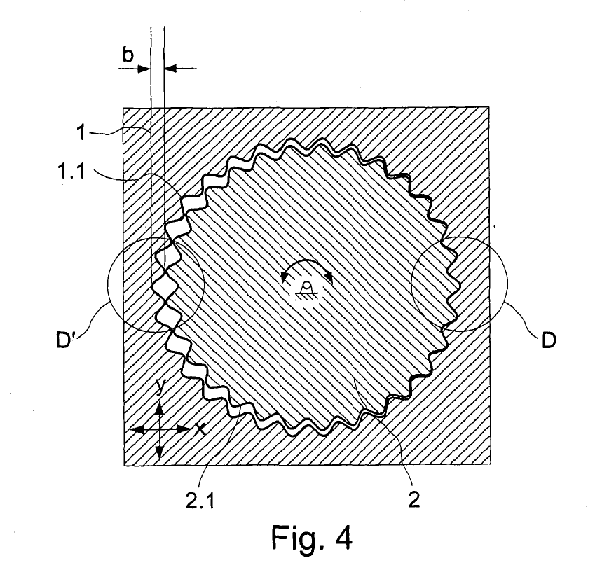

FIG. 4 shows a preferred embodiment of the toothing of the rotor and drive ring.

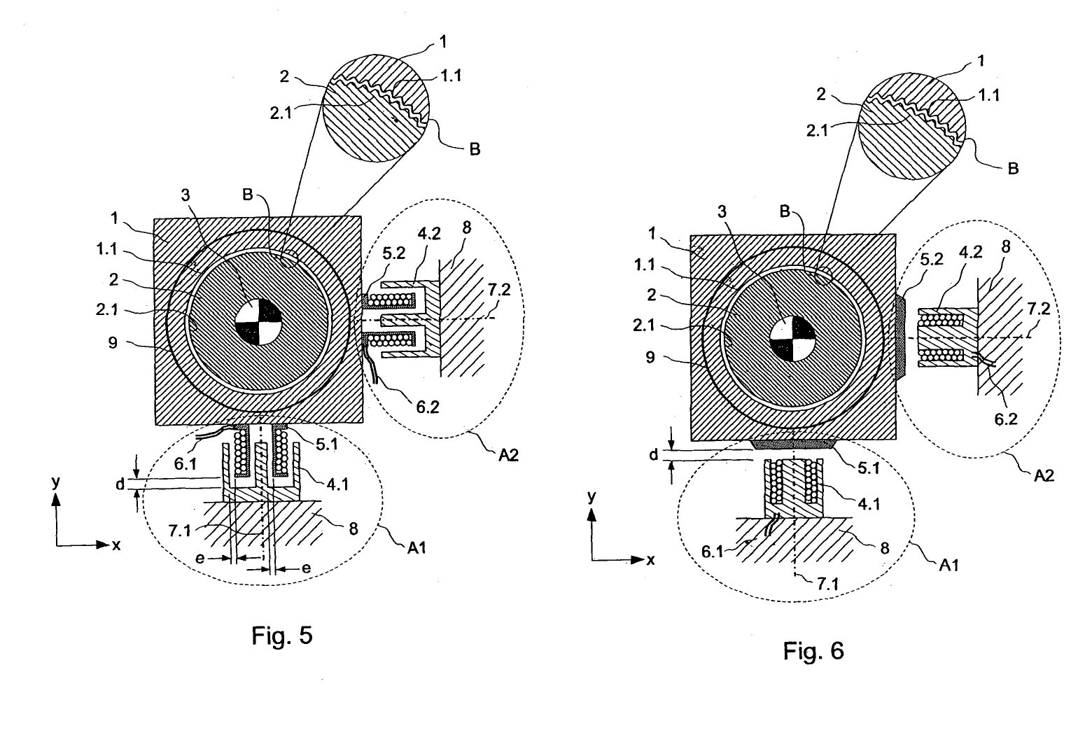

FIG. 5 shows a motor according to the invention with two electromagnetic voice coil magnets as actuators.

FIG. 6 shows a motor according to the invention with two electromagnets as actuators.

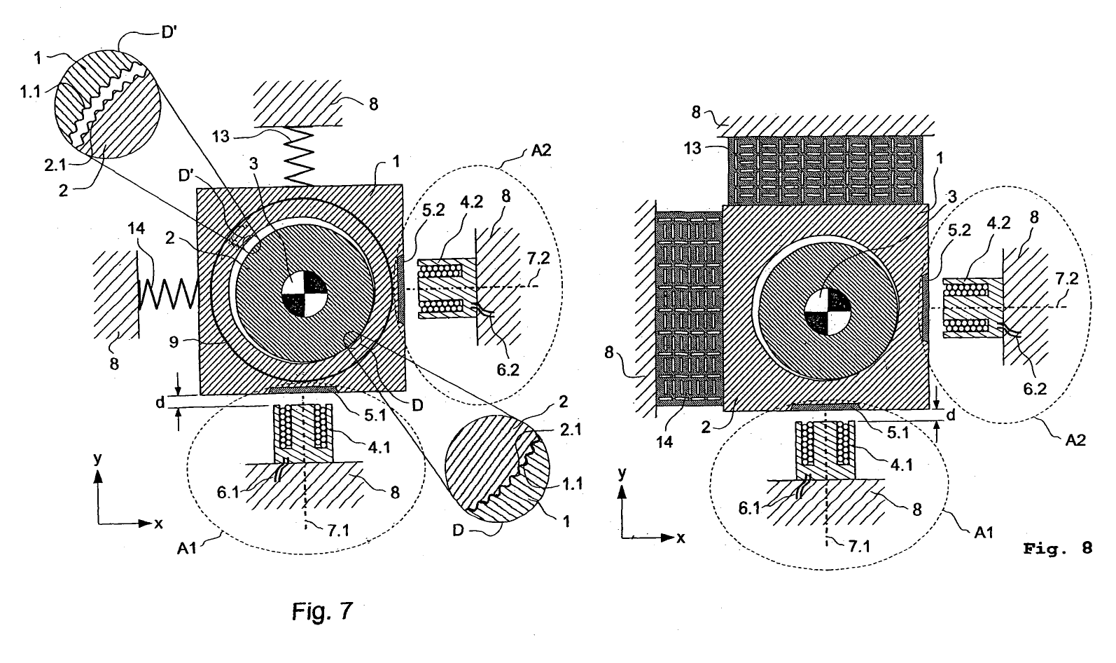

FIG. 7 shows a self-locking motor with two spring return elements and two electromagnets as actuators.

FIG. 8 shows a self-locking motor in which the spring return elements are slotted spring metal sheets and these serve simultaneously as a torque support, and also shows two electromagnets as actuators.

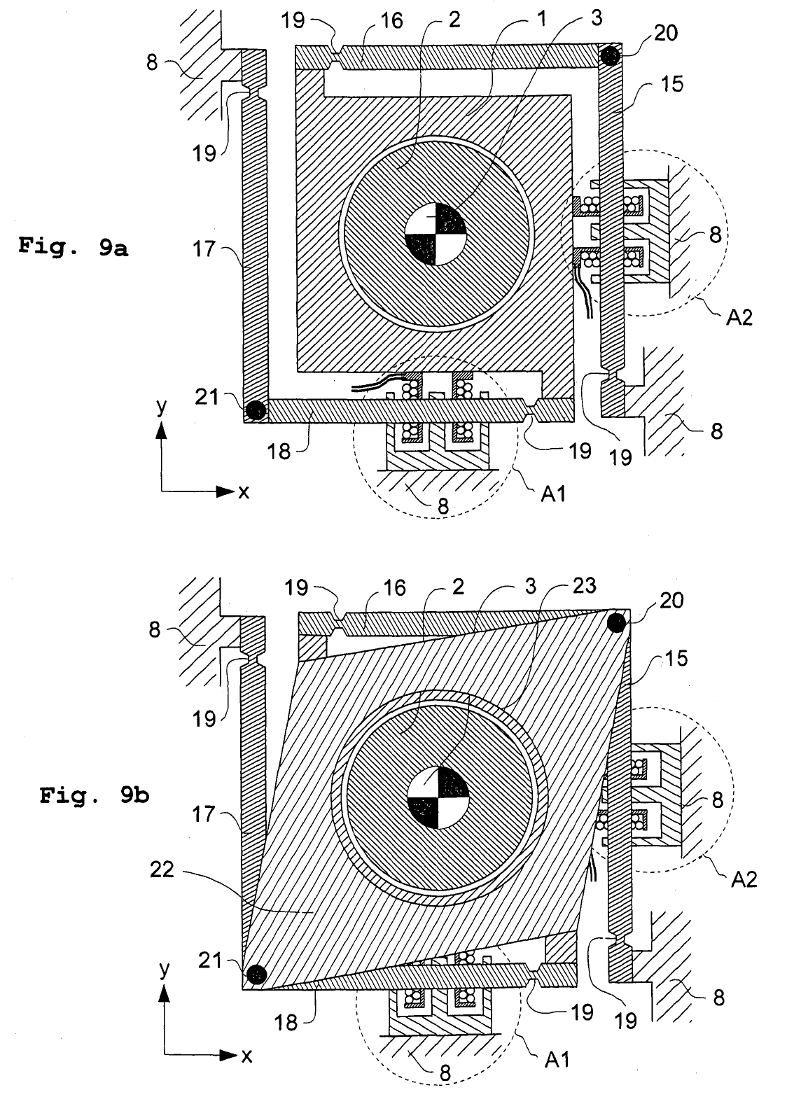

FIG. 9a shows a motor with part of a parallel kinematic torque support and two electromagnetic voice coils.

FIG. 9b shows a motor with a complete parallel kinematic torque support and two electromagnetic voice coils.

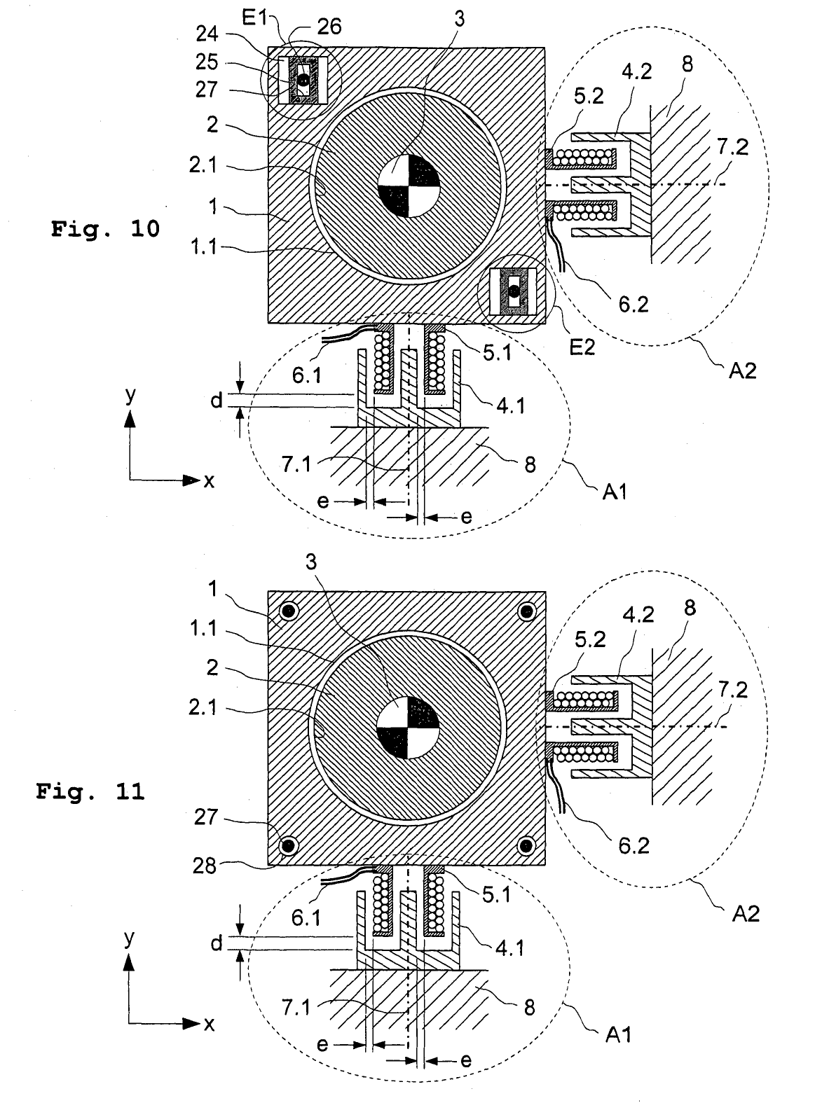

FIG. 10 shows a motor with sliding block guides as a torque support and two electromagnetic voice coils.

FIG. 11 shows a motor with bolt guides as a torque support and two electromagnetic voice coils.

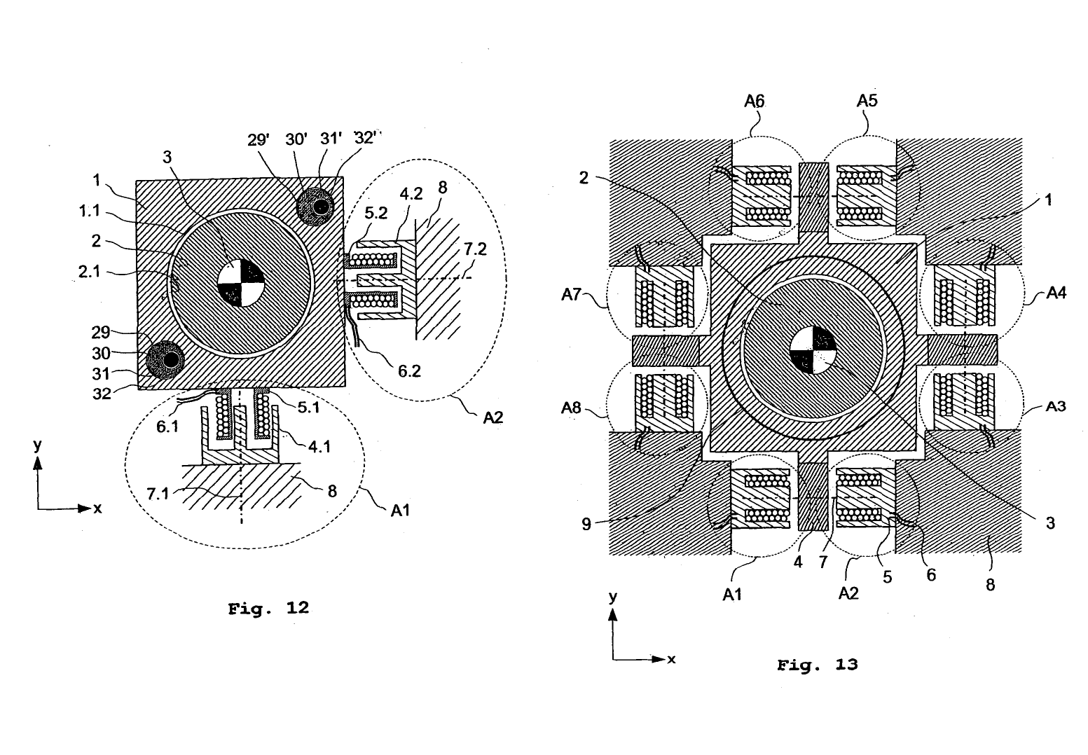

FIG. 12 shows a motor with an eccentric connecting rod as a torque support and two electromagnetic voice coils.

FIG. 13 shows a motor with eight electromagnets as actuators in a ring arrangement.

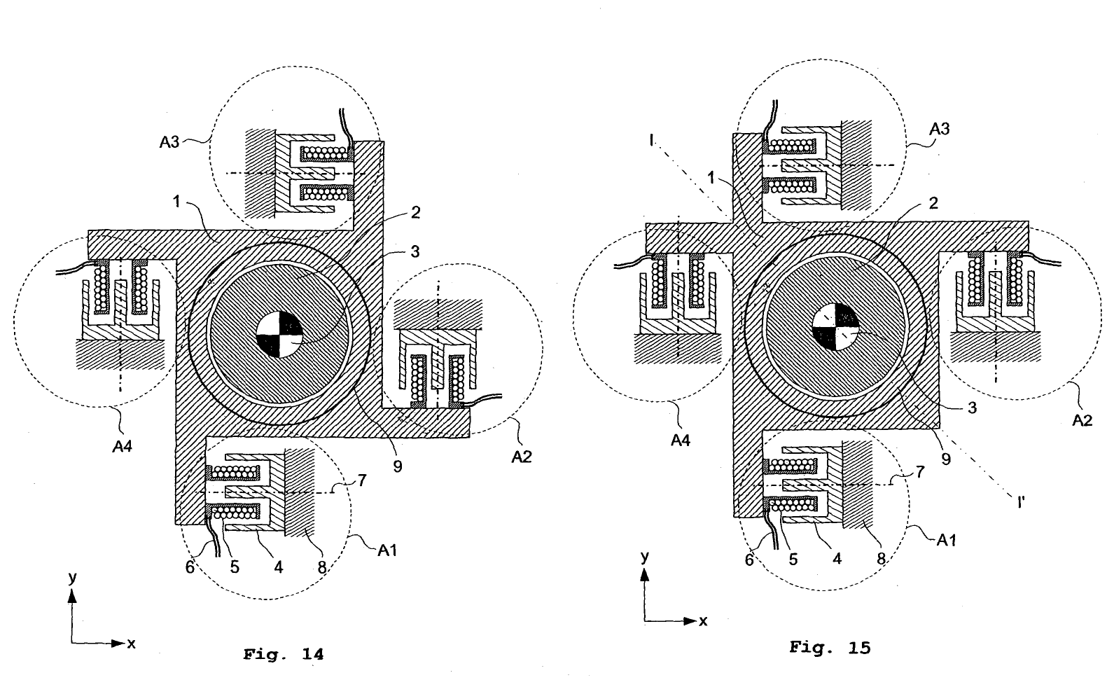

FIG. 14 shows a motor with four electromagnetic voice coils in a propeller arrangement.

FIG. 15 shows a motor with four electromagnet voice coils in a scissor arrangement.

FIG. 15 shows a motor with four electromagnetic voice coils in a rhombic arrangement.

FIG. 17 shows a motor with three electromagnets as drive elements in a 120 degree star arrangement.

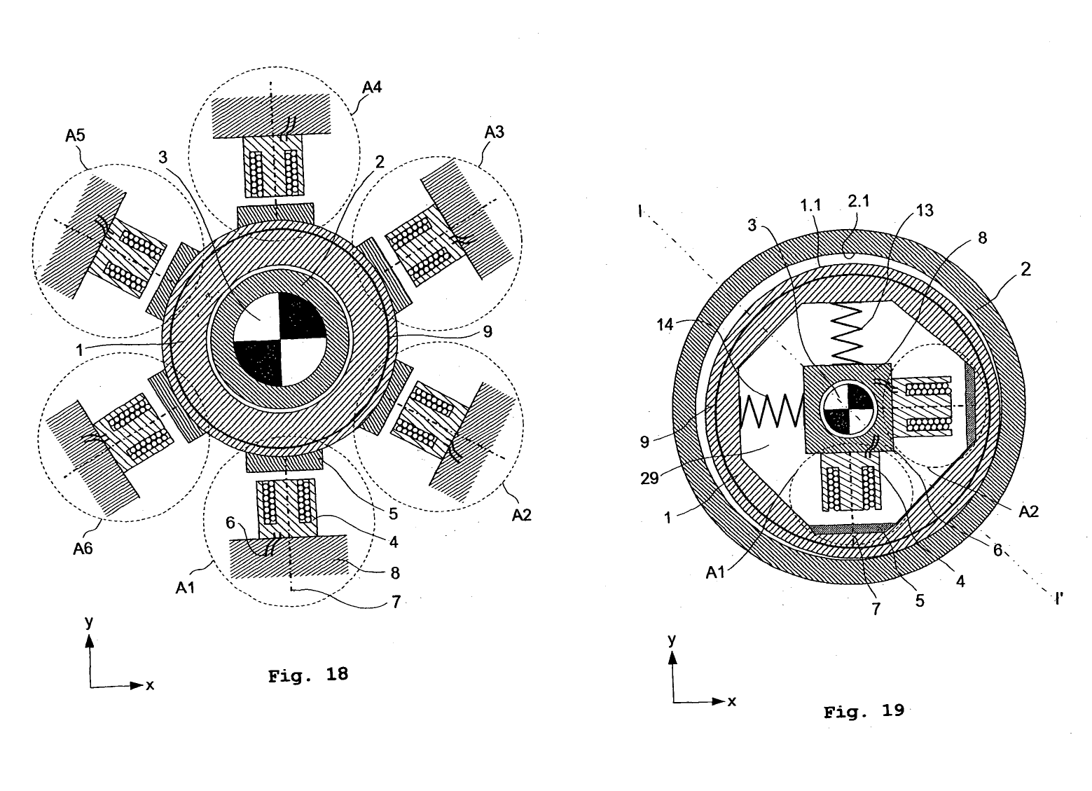

FIG. 18 shows a motor with six electromagnets as drive elements in a 60 degree star arrangement.

FIG. 19 shows a self-locking motor with an inwardly arranged drive ring, two electromagnets as drive elements and two spring return elements.

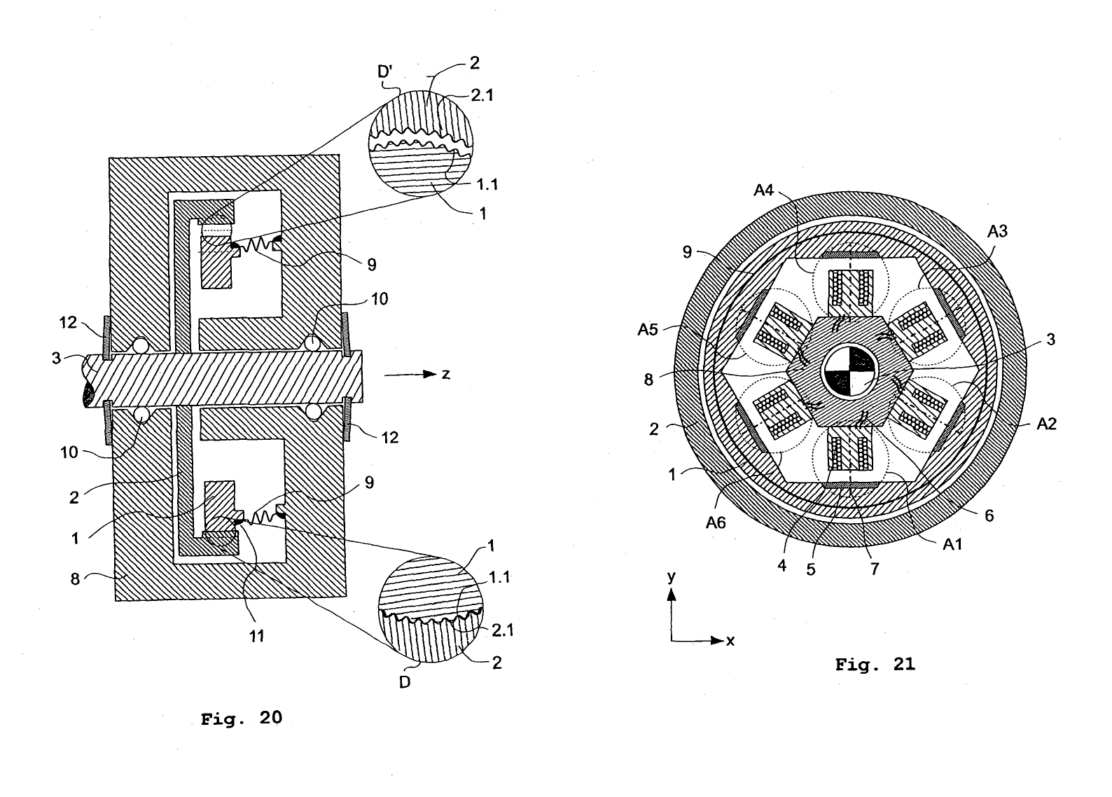

FIG. 20 shows a sectional illustration of the motor illustrated in FIG. 19 along the line I-I′ in FIG. 19.

FIG. 21 shows a motor with an inwardly arranged drive ring and six electromagnets as actuators in a 60 degree star arrangement.

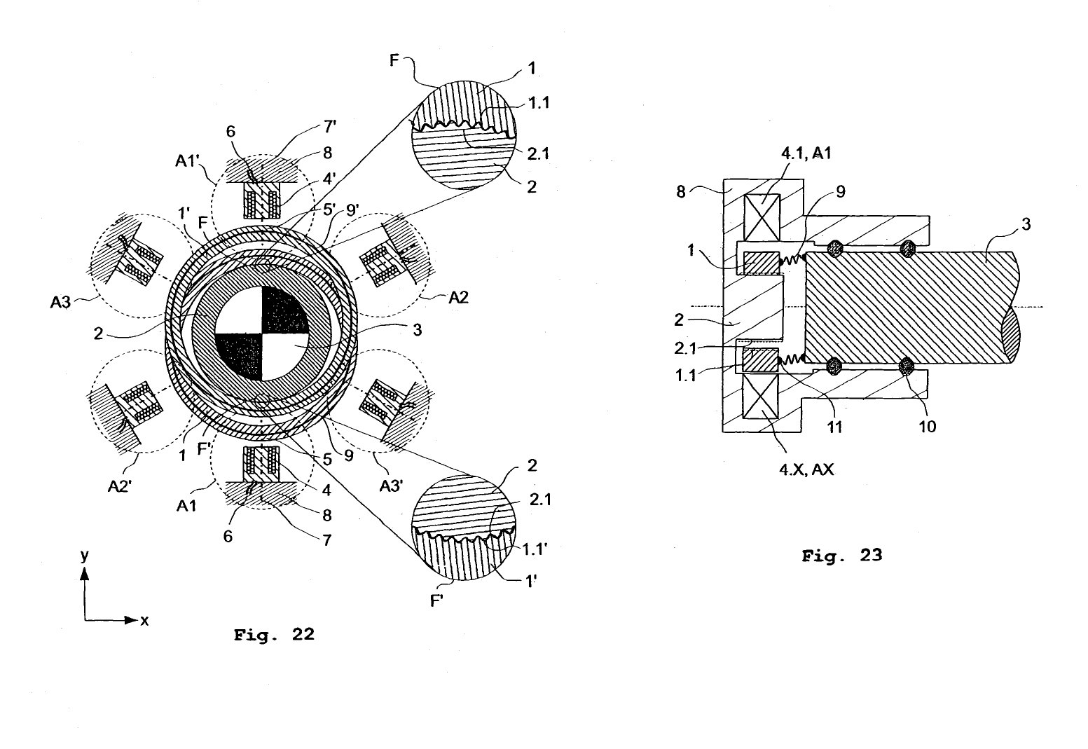

FIG. 22 shows a motor with two drive rings acting on a common rotor.

FIG. 23 shows a motor with outwardly arranged electromagnets, in which the rotation of the drive rotor is transferred to the motor shaft via a shaft coupling.

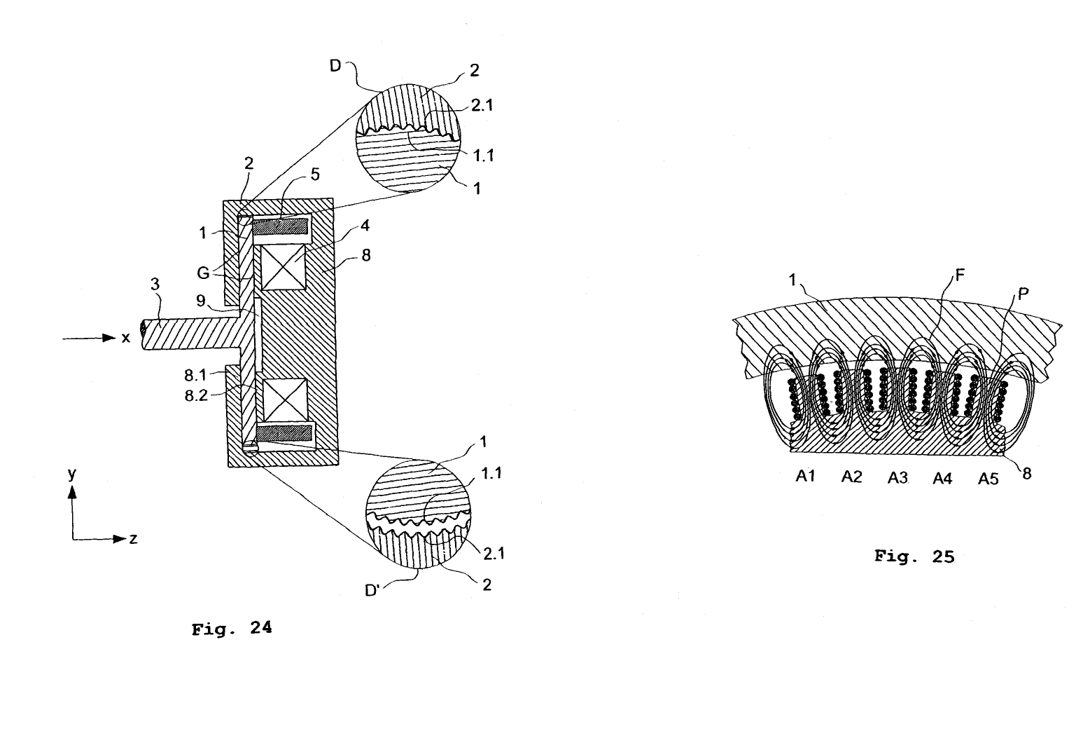

FIG. 24 shows a bearingless motor, in which the rotation of the motor shaft is superposed by a wobbling displacement movement.

FIG. 25 shows an advantageous embodiment of the electromagnets in the form of magnet poles, to which current is fed alternately.

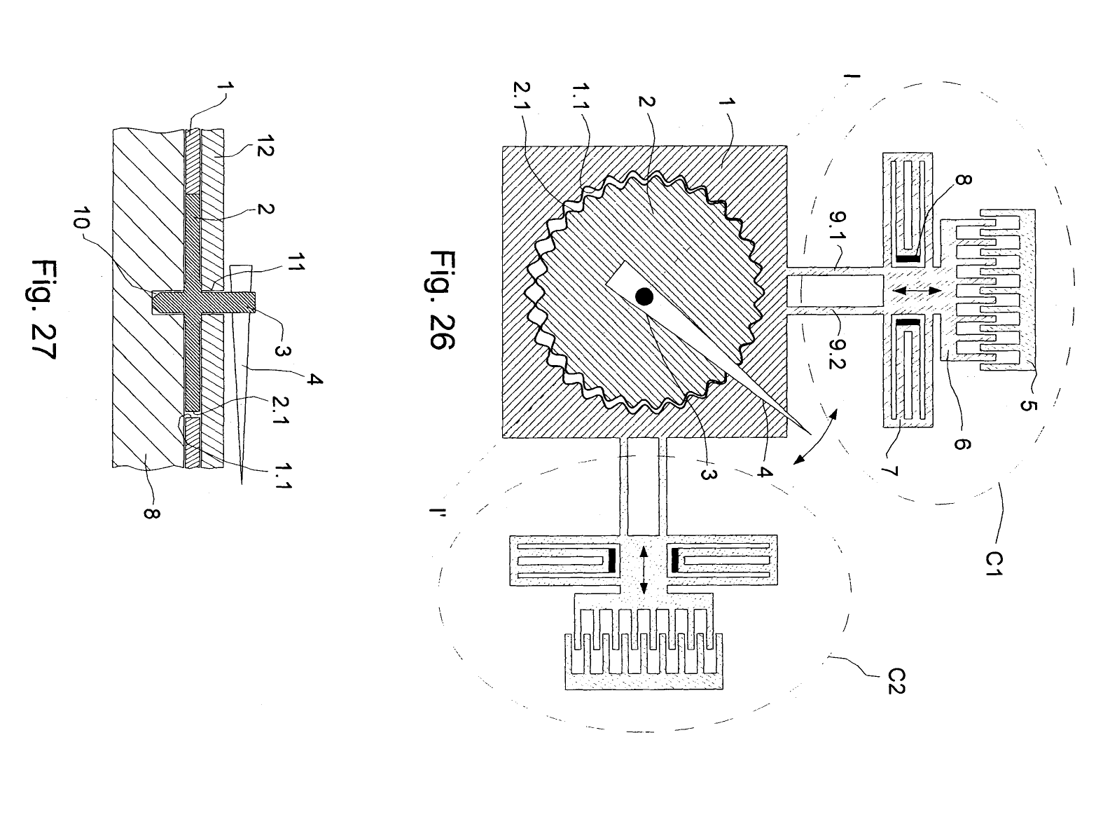

FIG. 26 shows a motor, in which the drive element is displaced by electrostatic actuators (combs).

FIG. 27 shows a sectional illustration of the motor illustrated in FIG. 26 along line I-I′ in FIG. 26.

FIG. 1 shows a sectional plan view of an electromechanical motor according to the invention. It has a circular rotor 2 of pitch diameter d_{R}, with a toothed outer peripheral surface 2.1 and a motor shaft 3 connected to the rotor 2 in a torque proof manner. The motor shaft 3 is mounted rotatably without play in bearings (not illustrated) of a motor housing 3. The electromechanical motor according to the invention further has a drive ring 1 as a drive element 1 with a toothed circular inner peripheral surface 1.1, which has a larger pitch diameter d_{A} compared to the toothed outer peripheral surface 2.1 of the rotor 2. As illustrated in the enlarged detail B in FIG. 1, the inner toothing 2.1 and the outer toothing 1.1 are formed in such a way that the teeth can engage in one another with a positive fit, wherein the outer toothing 1.1 has at least one tooth more than the inner toothing 2.1. In addition, the tooth profiles and the difference in the pitch diameters d_{A} and d_{R} are selected such that the rotor 2 and the drive ring 1 have the same module m, that is to say the condition d_{A}/z_{A}=d_{R}/z_{R} is met, where z_{A}=the number of teeth of the drive ring 1 and z_{R}=the number of teeth of the rotor 2, and therefore the toothing of the rotor 2 can roll in the toothing of the drive ring 1.

The electromechanical motor according to the invention has a torque support 9 as a central functional element, said torque support being attached between, the drive ring 1 and the motor housing 8. In the exemplary embodiment of a motor shown in FIG. 1, the torque support 9 has at least one bellows 9 oriented concentrically with respect to the motor shaft 3, one end of said bellows being connected mechanically to the drive ring 1 in a torque proof manner, and the other end of said bellows being connected mechanically to the motor housing 8 in a torque proof manner. The torque support 9 performs at least three functions in this case. Firstly, it is used as a fastening for the drive ring 1. Secondly, it enables displacement of the drive ring 1 in the xy plane arranged perpendicular to the motor shaft axis 3, wherein the torque support 9 is constructed such that it only opposes this displacements a low level of mechanical resistance. Thirdly, the torque support 9 prevents rotation of the drive ring 1 about the axis of the motor shaft 3 relative to the motor housing 8. For that purpose, the torque support 9 has maximum torsional rigidity with respect to rotation about the axis of the motor shaft 3. Elements that perform these functions include bellows, pipes, displacement kinematics, sliding block guides, bolts, bending elements, Cardan joints and springs, for example.

Furthermore, a first electromagnetic actuator A1 having two effective elements 4.1 and 5.1, and a second electromagnetic actuator A2 having two effective elements 4.2 and 5.2 are provided, wherein at least one of the effective elements of each actuator A1, A2 can be electrically excited via feed lines 6.1, 6.2. The effective elements 4 and 5 of each electromagnetic actuator A1, A2 are arranged at a distance d from one another along their respective primary effective axes, that is to say effective directions 7,1, 7.2, so that electromagnetic forces acting in a primary effective axis 7 can be generated between the effective elements 4 and 5 of each electromagnetic actuator A1, A2 by electrical excitation via the feed lines 6. The effective elements 4, 5 of the electromagnetic actuators A1, A2 according to the exemplary embodiment in FIG. 1 are oriented such that the primary effective axis 7,1 and the primary effective axis 7.2 form a right angle. The effective elements 4.1 and 4.2 are further connected fixedly to the motor housing 8, and the effective elements 5.1 and 5.2 are further connected fixedly to the drive ring 1. In this case it is irrelevant, in terms of function, which of the two effective elements 4, 5 of a primary effective axis is connected to the drive ring 1 and which is connected to the motor housing 8. With respect to an optimal dynamic behaviour of the electromechanical motor according to the invention, a minimal moved mass is sought. From this aspect, it can be advantageous to connect the effective element of smaller mass to the drive ring 1 and the effective element of greater mass to the motor housing 8. The drive ring 1 itself may also be used as an effective element, for example if the effective element 4 connected, to the motor housing 8 is an electromagnet and the drive ring 1 is formed in part or completely from ferromagnetic material, for example iron or steel, or has a permanent magnet or consists thereof.

Due to the positive contact with the rotor 2, the maximum deflection of the drive ring 1 when displaced in the xy plane is limited with respect to the axis of rotation of the motor shaft 3.

The distance d between the effective elements 4, 5 of each of the electromagnetic actuators A1, A2 is selected such that, when, the drive ring 1 is displaced, no mechanical contact can be produced between the effective elements 4, 5 of each of the electromagnetic actuators A1, A2.

The electromagnetic forces of some electromagnetic actuators, such as electromagnets, are highly dependent on the distance between the effective elements 4, 5, wherein the electromagnetic force increases strongly with decreasing distance. For this reason, the effective elements 4, 5 of each of the electromagnetic drive elements A1, A2 of the electromechanical motor according to the invention preferably have a minimal distance d, which is sufficiently large however to exclude mechanical contact between the effective elements 4.1 and 5.1 as well as between the effective elements 4.2 and 5.2 during motor operation.

FIG. 2 shows a sectional view of the electromechanical motor according to the invention along the sectional plane denoted by I-I′ in FIG. 1. The motor shaft 3 is mounted, rotatably without play in ball bearings 10 of a motor housing 8 via the rotor 2 connected mechanically to said motor shaft in a torque proof manner. Two disk springs 12, which engage in grooves in the motor shaft 3 and are supported at the motor housing 8, are used in this case to fix the motor shaft 3 axially.

The drive ring 1 is connected mechanically to the motor housing 8 in a torque proof manner with the aid of the torque support 9, which has two bellows 9.1 and 9.2 arranged concentrically with the axis of rotation of the motor shaft 3. The torque proof connection of the bellows 9.1 and 9.2 to the drive ring 1 on the one hand and to the motor housing 8 on the other hand is illustrated symbolically in FIG. 2 by welded seams 11. With regard to the torsional rigidity, maximum bellows diameters are particularly advantageous and can be achieved by fastening to the outer periphery of the drive ring 1. In a preferred embodiment according to the illustration in FIG. 2, the drive ring 1 is arranged centrally between two identical bellows 9.1 and 9.2. In this way it is achieved that the drive ring 1 is displaced purely in parallel under the effect of the forces exerted by the electromagnetic drive elements A1 and A2 in the xy plane arranged perpendicular to the motor shaft axis 3. In addition, a greater level of torsional rigidity is achieved by the two bellows 9.1 and 9.2 compared to one bellows.

In principle, the embodiment of an electromechanical motor according to the invention shown in FIG. 2 is also functional, however, with just one bellows, for example 9.1 or 9.2, or with two different bellows. Since the bellows is shear-compliant, the toothings of the rotor 2 and drive ring 1 are aligned parallel to one another by the forces generated by the electromagnetic actuators A1 and A2. The toothings may also be conical to compensate for the tilt angle of the one or more bellows.

FIG. 2 shows the electromechanical motor according to the invention in an operating phase in which the drive ring 1 is brought out of its central position and into contact with the rotor 2 as a result of the electromagnetic actuators A1, A2. The engagement conditions at two diametrically opposed points of the rotor 2 are illustrated in the enlarged details D and D′. In this case, enlarged detail D shows how the inner toothing 1.1 of the drive ring 1 is engaged with a positive fit with the outer toothing 2.1 of the rotor 2 in the region D, whereas the toothings of the rotor 2 and the drive ring 1 in the diametrically opposed region (see enlarged detail D′) are, at the same time, disengaged to a maximum extent.

For further explanation of the function of the electromechanical motor according to the invention illustrated in FIG. 1 and FIG. 2, it is generally assumed, without limiting the generality, that the effective elements 4.1 and 4.2 connected to the motor housing 8 are electromagnets with electrical connection lines 6.1, 6.2, and that the effective elements 5.1 and 5.2 connected to the drive ring 1 are permanent magnets, and therefore both attracting and repelling forces can be generated in the primary effective direction 7.1 between the effective elements 4.1 and 5.1 as well as in the primary effective direction 7,2 between the effective elements 4.2 and 5.2 by feeding current to the electromagnets 4.1, 4.2.

Proceeding from a starting position of the drive ring 1 defined by the toothing shape, the differences in pitch diameter and the assembly conditions, said drive ring is excited so as to be displaced in a cyclical and Circular manner, with a positive fit with the rotor 2, as a result of periodic forces of the electromagnetic actuators A1, A2 actuated in an electrically phase-shifted manner via the feed lines 6.1, 6.2.

FIG. 3 shows a current feed pattern suitable for operation of the electromechanical motor according to the invention shown in FIG. 1 and FIG. 2. In this case, the effective elements 5 have permanent magnets that are magnetised such that, when current is fed to the respective effective elements 4 formed as electromagnets, both attracting and repelling forces can be generated between the effective elements 4 and 5 of each of the electromagnetic actuators A1, A2. To generate a peripheral circular displacement of the drive ring 1, the electromagnetic actuators A1, A2 are operated by means of control signals that are phase-shifted in relation to one another. By way of example, FIG. 3 shows a suitable actuation pattern, with a current profile of the electromagnetic actuators according to:

I_{A1}(t)=Iₘₐₓ·sin [φ(t)](amperes)

I_{A2}(t)=Iₘₐₓ·sin [φ(t)±π/2](amperes),

wherein I_{A1} is the current through the electromagnetic actuator A1, I_{A2} is the current through the electromagnetic actuator A2, Iₘₐₓ is the maximum current and φ(t) is the phase angle in radian. By changing the phase relation of the two coil currents I_{A1}(t), I_{A2}(t) by ±π/2, the direction of rotation of the motor shaft of the motor is commutated.

On the basis of the exemplary embodiment shown in FIG. 1 and FIG. 2, motor function will be explained hereinafter in greater detail in conjunction with the actuation pattern shown in FIG. 3.

Due to the feed of current to the electromagnet 4,1 with a sinusoidal current profile and due to the current feed of the electromagnet 4.2 with a cosinusoidal current profile of equal frequency f[Hz], sinusoidal forces phase-shifted by 90 degrees in relation to one another act simultaneously on the effective elements 5.1 and 5.2 in the primary effective directions 7.1 and 7.2 of the electromagnetic actuators A1, A2 and are superposed linearly to produce a circular displacement movement of the drive ring 1. In this case, the forces acting on the drive ring 1 are approximately proportional to the electric current through the electromagnets. Since the maximum deflection of the drive ring 1 is limited by the rotor 2, a contact force is established between the rotor 2 and the drive ring 1 that brings the toothings 1.1 and 2.1 into engagement in the contact region. The contact region revolves along the periphery of the drive ring 1 with the circular frequency f[Hz] of the electrical current, wherein the outer surface 2.1 of the rotor 2 roils with a positive fit over the inner surface 1.1 of the drive ring 1, and the rotor 2 is rotated with the motor shaft 3. The direction of rotation of the rotor 2 is oriented in a direction opposite the direction of revolution of the circular displacement of the drive ring 1. It is controlled by the phase relation of the electrical control signals 6.1, 6.2 of the electromagnets. By changing the electrical control frequency f[Hz] from zero to a few kilohertz, the speed of rotation of the motor shaft 2 can be controlled within wide limits. A particular advantage lies in the fact that, due to the fixed phase relation between electrical radian frequency f[Hz] and rotational frequency Q[Hz] of the motor shaft 3, any further angular position can be reached without additional sensor technology with knowledge of a starting angular position of the motor shaft 3. The motor shaft 3 can thus be held in any desired angular positron.

External torques acting on the motor shaft 3 are braced at the motor housing 8 by the at least one bellows 9.1, 9.2 acting as a torque support 9. Due to the finite torsional rigidity of the torque support 9 comprising the at least one bellows 9.1, 9.2, a torque-proportional twist of the drive ring 1 in relation to the motor housing 8, even if only small, does occur in the event of torques acting on the motor shaft 3. The torque support 9 is dimensioned such that the torque-dependent twist of the drive ring 1 is low, and therefore the toothings 1.1 and 2.1 are not disengaged as a result thereof. Due to the load-proportional twist of the drive element 1 in relation to the motor housing 8 and therefore of the effective elements 4 in relation to the effective elements 5, the inductances of the electromagnetic actuators A1, A2 change proportionally to the load torque. The change to the inductances of the magnetic circuits of the actuators A1, A2 is evaluated electronically and is used for torque detection.

FIG. 4 shows a preferred, embodiment of the toothings of the rotor 2 and drive ring 1 of the electromechanical motor according to the invention shown, in FIG. 1 and FIG. 2, in which the rotor 2 has a number of n teeth and the drive ring 1 has a number of n+1 teeth, and the outer peripheral surface of the inner toothing 1.1 of the drive ring 1 has a diameter that is greater by the amount b compared to the outer peripheral surface of the outer toothing 2.1 of the rotor 2. As a result, the teeth of the rotor 2.1 are thus engaged with a positive fit with the teeth of the drive ring 1.1 in a region D, and the teeth of the rotor 2.1 and drive ring 1.1 are disengaged in the region D′ diametrically opposed from the region D. In this case, the difference in diameter b corresponds at least to the height of the teeth, and therefore the teeth of the drive ring 1 can be moved past the teeth of the rotor 2.

The embodiment of the toothings illustrated in FIG. 4 in which the difference in diameter b corresponds to tooth height and additionally to a low tolerance is particularly advantageous in all embodiments. Since the teeth of the rotor 2 and drive ring 1 are exactly opposite in the region D′ opposite the region of engagement D, the toothing cannot be disengaged. It therefore has self-guiding properties. A sinusoidal tooth profile is also advantageous for the design of the toothing in all embodiments of the invention. In conjunction with, a small difference in the number of teeth, ideally of 1, there is thus always a relatively large number of teeth in engagement. Due to the high degree of overlap of the toothings of the rotor 2 and drive ring 1, a favourable load distribution and a high robustness of the toothings with respect to overload are achieved.

To generate high torques and a high angular resolution, the basic type of an electromechanical motor according to the invention illustrated in FIG. 1 and FIG. 2 may advantageously have fine toothings or micro-toothings with a very small module m, with tooth heights typically of ≦200 μm, preferably ≦100 μm, more preferably ≦50 μm, at the rotor 2 and drive ring 1. Consequently, the rotor 2 and drive ring 1 have a very high number of fine teeth with a small difference in the number of teeth, thus resulting in very high inner transmission ratios T of the motor of one/a few thousand. In particular, for a difference of 1 in the number of teeth between the drive ring 1 and the rotor 2, there is a minimal stroke requirement in order to roll the toothings in one another, which permits a spatially close arrangement of the effective elements 4, 5 of each electromagnetic actuator A1, A2 with a minimal distance d, whereby very high forces along the effective axes 7 are exerted from the effective elements 4 and 5 onto the drive ring 1, and very high torques can be generated.

The electromechanical motor according to the invention can also be operated, however, with much rougher toothings having tooth heights ≧100 micrometers.

As a further embodiment, FIG. 5 shows an electromechanical motor according to the invention, in which electromagnetic voice coils 5 arranged in the air gap of permanent magnets 4 are used as actuators A1, A2. The voice coils 5 can be fed with current via. electrical feed lines 6. The magnetic flux of the permanent magnets 4 is oriented in the air gap such that magnetic forces directed in the effective axis 7 are effective when current is fed to the voice coils 5. The arrangement shown in FIG. 5, in which the active effective elements 5 formed as voice coils are fastened to the drive ring 1 and the passive effective elements 4 formed as permanent magnets are fastened to the motor housing 8, is merely exemplary. The passive effective elements 4 can also be fastened to the drive ring 1, and the active effective elements 5 can also be fastened to the motor housing 8, or both effective elements 4 and 5 of each electromagnetic actuator A1, A2 may comprise active effective elements.

Depending on the design of the toothings of the rotor and drive ring, the toothings of the rotor and drive ring may be engaged in part or completely or not at all in the starting position in which there is no current feed. The enlarged detail B in FIG. 5 shows a state in which the toothings are engaged in part. Proceeding from a starting position of the rotor 2 and drive ring 1 in the state in which there is no current feed, the motor shaft is rotated either to the right or to the left, depending on the phase relation, by a supply of current to the electromechanical actuators A1, A2. The distances d and e between the voice coils and the surfaces of the pot magnets are selected in accordance with the maximum possible displacement of the drive ring 1 in the xy plane, such that contact between the effective elements 4 and 5 is reliably prevented during motor operation.

Compared to the embodiment illustrated in FIG. 5, FIG. 6 snows an electromechanical motor according to the invention in which the active effective elements 4 are fastened to the stationary motor housing 8. The effective elements 4 are formed by powerful electromagnets, in each case a coil with the electrical connections 6 and having a high-permeability coil body. Permanent magnets 5 connected, to the drive ring 1 and positioned opposite the electromagnets 4 in the effective axis 7 are used as passive effective components 5. The operating principle corresponds to that already described for FIG. 5. The rotor can be rotated both to the right and to the left as a result of phase-shifted current feed of the electromagnetic actuators A1, A2 and can be held in any position.

In contrast to the previously described embodiments, FIG. 7 shows an electromechanical motor according to the invention, which is self-locking when no current is fed. Springs 13 and 14 arranged diametrically opposite the electromagnetic actuators A1, A2 are used for this purpose. The springs 13, 14 are each supported between the motor housing 8 and the drive ring 1. Their effective direction is, in this case, oriented in the direction of the effective axis of the opposite electromagnetic actuator. Each of the two springs 13, 14 is mechanically biased and exerts a tensile force onto the drive ring 1. The drive ring I is thus held in positive engagement with the rotor 2 in the region D when no current is fed. to the electromagnetic actuators A1, A2, whilst the toothings of the rotor 2 and drive ring 1 are maximally distanced in the position D′ diametrically opposite the region D.

On the assumption that the tension springs 13, 14 exert tensile forces of equal magnitude onto the drive ring 1, the region D lies over the axis of symmetry formed by the two electromagnetic actuators A1, A2, between the two electromagnetic actuators A1, A2. The rotor 2 is thus locked against rotation when no current is fed to the actuators A1, A2.

In this case, effective elements 4 and 5 act as electromagnetic actuators and generate substantially tensile forces when current is fed. In a simplest embodiment, the passive effective element 5 fastened to the drive ring 1 comprises a high-permeability ferromagnetic material, and the active effective element 4 comprises an electromagnet. A further simplification can be achieved by producing the drive ring 1 itself from ferromagnetic material in the regions in which the separate effective elements 5 are otherwise fastened. Furthermore, the entire drive ring 1 may also comprise, or consist of, ferromagnetic material. So as to rotate the motor shaft 3, the electromagnetic actuators A1, A2 are fed with current in the phase-shifted sinusoidal manner already described. The electromagnetic actuators A1, A2 are both dimensioned such that the tensile force generated when current is fed corresponds to approximately twice the magnitude of the tensile force exerted by the respective tensile springs 13, 14.

The arrangement shown in FIG. 7 is preferably suitable in combination with pull-type electromagnets, with which the drive ring 1 is displaced in a circular manner in cooperation with the static forces exerted by the springs 13, 14 and the periodically sinusoidal modulated forces exerted by the actuators A1, A2. Since, for uniform running of the motor, the forces of the tension springs naive to be overcome on the one hand and a contact force of equal magnitude has to be generated in position D′ opposite the rest position D on the other hand, the current profile is displaced by a bias current corresponding to the overcoming of the forces of the tension springs, as illustrated in FIG. 3.

The drive ring 1 can therefore be excited so as to be displaced in a revolving manner with constant radial contact force as a result of a bias current and phase-shifted sinusoidal actuation of the drive elements A1, A2.

The exemplary embodiment shown in FIG. 7 makes it possible to hold the rotor 2 in any angular position without current with only a small angle error and to rotate the rotor 2 out of thus position by electrical actuation of the actuators A1, A2.

It is advantageous for the function of the motor according to the invention if the drive ring 1 is fixed so as to be torsionally rigid with respect to the motor shaft axis on the one hand and so that transverse displacement of said drive ring in the xy plane arranged perpendicular to the motor shaft axis is enabled on the other hand. Elements that meet this condition can be referred to as a torque support 9. In the previous exemplary embodiments of the electromechanical motor according to the invention, a rotationally symmetrical structure in the form of bellows or pipes was used for these functions. This is just one of a multiplicity of further embodiments for the torque support 9, however.

FIG. 8 shows an electromechanical motor according to the invention of the design according to FIG. 7, in which the tension springs are formed by slotted spring metal sheets 13 and 14. With a suitable design of the spring characteristic as a result of corresponding slot geometries and a sufficient aspect ratio, which is defined by the width of the springs with respect to their length in the primary spring direction, the slot springs 13, 14 can simultaneously act as a torque support 9. The attachment of an additional torque support 9 to the drive ring 1 is therefore optional and is not compulsory for motor function.

As a further example, FIG. 9a and FIG. 9b show an embodiment of the electromechanical motor according to the invention with a parallel-kinematic suspension of the drive ring 1, serving as a torque support 9, to arms 15, 16, 17, 18, which are resistant to tension and compression with respect to the xy plane, but are flexible, said mode of fixing being cross-braced at the opposed pivot points 20, 21 by a strut 22 that is resistant to tension and compression. The interaction of the elements 15, 16, 17, 18, 19, 20, 21, 22 achieves the functions of a torque support in a manner similar to that of the element denoted previously by 9. All elements are arranged in a substantially planar manner in the xy plane. Each of the effective elements 5 of the actuators A1, A2 illustrated as voice coils in the exemplary embodiment of FIG. 9 is connected to the drive ring 1 in the manner already illustrated in FIG. 5. Due to the penetration, the arms 15 and 18 are therefore either provided with passages in the region of the electromagnetic actuators A1, A2, or are guided around the actuators A1, A2 in the z direction. In another embodiment not illustrated, in the figures, one of the effective elements 5 of each of the electromagnetic actuators A1, A2 is connected directly to the arms 15, 18 or 16, 17. In addition to a simpler construction, any desired leverage ratios can thus be provided for the forces generated by the drive elements A1, A2 and transferred onto the drive ring 1.

A structure that is compliant with respect to displacements in the xy plane is achieved by a first arm 15, which is connected at one end to the motor housing 8, and by a second arm 16, which is connected at one end to the drive ring 1, as well as by an angular flexible interconnection 20 of the arms 15 and 16 at their respective other ends. Maximum angular flexibility and torsional flexibility is achieved by solid state hinges 19 or pivot joints 20, 21. Both embodiments are shown by way of example in FIG. 9. The kinematic structure illustrated in FIG. 9 can, however, be implemented both merely with solid state hinges 19, and also with conventional pivot joints 20, 21.

By attaching a second arm structure, which has a pivot point 21, is rotated by 180 degrees in relation to the arms 15, 16, consists of the arms 17, 18 and is fastened to the drive ring 1 and to the motor housing 8, the drive ring 1 can be suspended so as to be displaceable in the xy plane, wherein the structure formed in this way is still week against twisting. The embodiment according to the invention of the torque support 9 shown in FIGS. 9a and 9b is based on the knowledge that the distance between the pivot points 20 and 21 changes when the drive ring 1 is twisted. The cross strut 22 shown in FIG. 9b and attached between the pivot points 20 and 21 prevents such changes in spacing, but does not impair the displacement of the drive ring 1 in the xy plane. For reasons of clarity, FIG. 9a shows the kinematics without the cross strut 22, and FIG. 9b shows the kinematics with the cross strut 22. The cross strut 22 has an inner recess 23, through which the motor shaft 3 is passed. The structure illustrated in FIG. 9b thus performs the function of a torque support 9 within the desired scope.

FIG. 10 shows an exemplary embodiment of the electromechanical motor according to the invention, in which the torque support 9 has sliding block guides E1, E2. The sliding block guide E1 has a rectangular recess 24 in the drive ring 1, in the interior of which a frame 25 that is movable without play with respect to displacements in the x direction is arranged and has an elongate inner recess 27, into which a bolt 26 connected fixedly to the motor housing 8 is guided without play such that the frame 25 is also moved together with the drive ring 1 in the event of displacement in the y direction. The elements 24, 25, 26, 27 are dimensioned such that they can slide in a low-friction manner, but without play.

A particularly effective blocking of twisting of the drive ring 1 with no impairment of displacement of the drive ring 1 in the xy directions is achieved by the attachment on the drive ring 1 of at least one second sliding block guide E2 at the greatest possible distance from the sliding block guide E1, as illustrated in FIG. 10.

FIG. 11 shows a further embodiment of the torque support 9. This has round bolts 27 of outer diameter d₁, which are connected fixedly to the motor housing 8 and are guided into circular recesses 28 of inner diameter d₂, where d₂>d₁, in the drive ring 1, wherein, the difference in diameter d₂−d₁ corresponds at least to the maximum path of displacement of the drive ring 1. To prevent twisting of the drive ring 1, at least two antitwist protection mechanisms comprising the elements 27 and 28 should be provided on the drive ring 1. To minimise the rotational play of the drive ring 1 when commutating the direction of rotation of the rotor 2, it is likewise desirable for the difference in diameter d₂−d₁ to correspond as accurately as possible to the maximum path of displacement of the drive ring 1. Due to a multiplicity of elements 27, 28 attached to the drive ring, a high level of torsional rigidity of the drive ring 1 can be achieved with simultaneous displaceability.

In the exemplary embodiment shown in FIG. 12, two eccentric connection, rods are used as a torque support.

A first eccentric connection rod has a round recess 29 in the drive ring 1. The round connecting rod eye 30 mounted without play, yet rotatably is located within the recess 29. The connecting rod eye 30 has a circular recess 31 attached eccentrically relative to its axis of rotation, said recess surrounding the round journal, connected to the motor housing 8, without play, yet rotatably. At least one second eccentric connecting rod of identical design comprising the elements 29′, 30′, 31′, 32′ is located on the drive ring 1 at the greatest possible distance from the first eccentric connecting rod comprising the elements 29, 30, 31, 32. The eccentricity of the eccentric connecting rod is selected such that it corresponds to the maximum path of displacement of the drive ring 1. The drive ring 1 can thus be displaced only in parallel in the xy plane in FIG. 12 by the actuators A1, A2, but cannot rotate.

In the following exemplary embodiments, the indexing of the elements of each individual electromagnetic actuator is omitted for reasons of clarity. The basic elements of the electromechanical motor according to the invention are provided with consistent reference signs, however.

FIG. 13 shows a variant of the electromechanical motor according to the invention, having eight electromagnetic drive elements A1 . . . A8, wherein each two electromagnetic actuators, for example A1, A2, arranged in a mirror-inverted manner with respect to a respective effective element 4 act on a common effective element 4 protruding radially from the drive ring 1. Furthermore, the effective axes 7 of the electromagnetic actuators A1 . . . A8 are not directed radially toward the motor shaft 2. The effective elements 5 associated with an effective element 4 are in this case actuated such that the forces exerted onto the effective element 4 are suitably superposed. If the actuator A2 in FIG. 13 exerts a force onto the effective element 4 in the x direction for example, the drive element A1 is actuated such that it likewise exerts a force in the x direction, or does not exert any force at all onto the effective element 4. A further associated drive element pair on the drive ring is located diametrically opposite the drive element pair associated with an effective element. The actuator pair A5, A6 is associated with the actuator pair A1, A2, and the actuator pair A6, A7 corresponds likewise with the actuator pair A3, A4. To generate the rotation of the motor shaft 3, the individual drive elements A1 . . . A8 are operated in a synchronised manner such that a revolving displacement of the drive ring 1 appears. To this end, the actuators having the same effective direction, that is to say A1 with A6, A2 with A5, A3 with A8, and A4 with A7, can be electrically interconnected to form groups G1, G2, G3, G4 and can be operated, jointly from an actuation source associated with a respective group. The phase shift between the individual groups G1 . . . G4 is in turn to be selected such that a revolving displacement of the drive ring 1 is generated. Due to the high number of actuators A1 . . . A8 acting on the drive ring 1, the design shown in FIG. 13 enables a high torque of the electromechanical motor according to the invention.

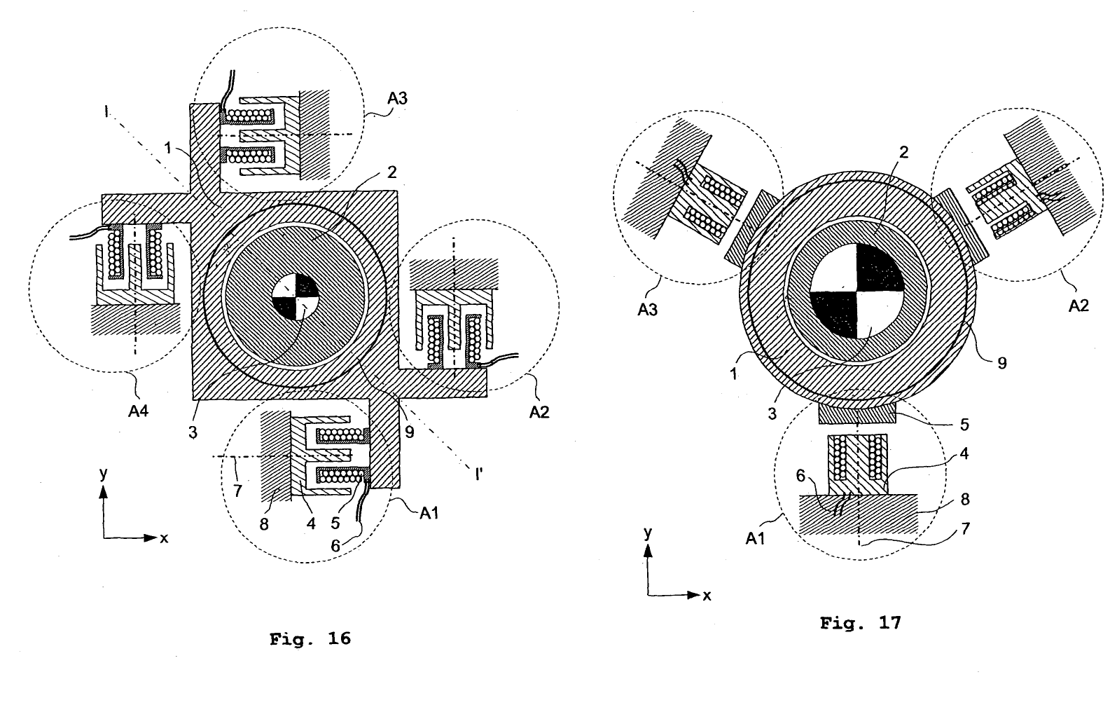

Depending on the application, it may be necessary to adapt the package and design of the electromechanical motor according to the invention to the spatial requirement provided. In this regard, the motor according to the invention provides a high level of freedom in terms of design, as shown by the configurations shown merely by way of example in the exemplary embodiments according to FIG. 14, FIG. 15 and FIG. 16.

FIG. 14 shows a rotationally symmetrical design of the electromechanical motor according to the invention with wing-like corners of the drive ring 1, to which voice coils are fastened as effective elements 5 of the four drive elements A1 . . . A4.

FIG. 15 shows a design that is mirror-symmetrical about an axis I-I′ and has four actuators A1 . . . A4.

FIG. 16 shows a narrower design that is likewise mirror-symmetrical about am axis I-I′ and has mutually opposed actuators.

With respect to the uniformity of the rotation, a symmetrical arrangement and transfer of force of the N electromagnetic actuators at the periphery of the drive ring 1 is advantageous in principle. FIG. 17 shows a design, which is improved in this respect, of an electromechanical motor according to the invention with three actuators A1, A2, A3 arranged, symmetrically, at an angular distance α of 120 degrees, over the periphery with respect to the axis of rotation of the motor shaft 3 in accordance with the relation

N>2→α=360°/N

The electromagnetic actuators can be designed such that they make it possible to generate either only attracting, only repelling, or both attracting and repelling forces between the effective elements 4 and 5 along the respective effective axis 7.

As functional elements, the motor illustrated in FIG. 17 has a rotor 2 with a motor shaft 3 fastened, in a torque proof manner, a drive ring 1 surrounding the rotor 2, and a torque support 9 fastened between the drive ring 1 and the motor housing 8. The rotor 2 and drive ring 1 are provided in the manner already illustrated with toothings that can roll into one another with a positive fit. To rotate the rotor 2, signal voltages that are phase-shifted in relation to one another are applied to the three actuators A1, A2, A3, The actuators can be electromagnets of any design.

FIG. 18 shows a further development of the electromechanical motor according to the invention from figure 17 with six drive elements A1, A2, A3, A4, A5, A6 attached symmetrically over the periphery of the drive ring 1 at an angular distance of 60 degrees. In addition to the even greater level of torque, the number of six drive elements also ensures a further increased uniformity of rotation of the rotor 2.

The maximum number of actuators of a drive ring is unlimited in principle. Of course, more actuators can be attached to a drive ring of greater diameter than to drive rings of smaller diameter. In practice, the available installation space therefore defines an upper limit for the maximum number of actuators.

To achieve very high torques, the motor according to the invention may have a large rotor diameter. In this case, the inner region of the drive ring 1 may advantageously be used to place the actuators in a space-saving manner.

FIG. 19 shows an exemplary embodiment for a motor that functions similarly to FIG. 7 and FIG. 8, but with a. much greater diameter of the rotor 2 compared to FIG. 7 and FIG. 8, in which the actuators A1, A2 and the tension springs 13, 14 are arranged in an inner hollow region 29 of the drive ring 1 in a space-saving manner. In this case, the rotor 2 is formed as an annular or pot-shaped element, which surrounds the drive ring 1 with an oversize. In contrast to the previous exemplary embodiments, the rotor 2 now has toothings on the inner peripheral surface 2.1 and the drive ring on the outer peripheral surface 1.1, which can roll into one another with a positive fit, wherein the rotor 2 has at least one tooth more than the drive ring 1.

The tension springs 13, 14 are articulated between the drive ring 1 and the motor housing block 8, which simultaneously acts as a duct for the motor shaft 3. By biasing the springs 13 and 14, a tensile force acting in a longitudinal axis of the respective springs is exerted onto the drive ring 1, whereby said drive ring is held in positive engagement with the rotor 2 in the region between the actuators A1, A2 when no current is fed to the actuators A1, A2. The electromechanical motor according to the invention is thus self-locking in the same way as in the exemplary embodiments of FIG. 7 and FIG. 8.

To further illustrate the design and function. FIG. 20 shows a section along line I-I′ of the exemplary embodiment illustrated in FIG. 19. The electromechanical motor according to the invention has a motor shaft 3, which is mounted rotatably without play in the motor housing 8 by two ball bearings 10 and is fixed axially by two disk springs 12.

The rotor 2 is designed as a pot-shaped element connected in a torque proof manner to the motor shaft 3, said element surrounding the drive ring 1. The drive ring 1 is connected to the motor housing 8 by a torque support 9 designed in the form of bellows so as to be transversely displaceable in the plane perpendicular to the motor shaft axis 3, but torsionally rigid with respect to the motor shaft axis 3. The mechanically fixed connection of the bellows 9 to the drive ring 1 and to the motor housing 8 is indicated symbolically in FIG. 20 by exemplary weld seams 11. The rotor 2 has a toothing 2.1 on its inner peripheral surface, and the drive ring has a toothing 1.1 on its outer peripheral surface, as illustrated in the enlarged details D and D′. FIG. 20 shows the motor in an operating phase, in which the toothing is engaged in a lower region illustrated by the detail D, and is completely disengaged in an upper region illustrated in an enlarged manner by the detail D′.

The function of the motor is similar to that in the exemplary embodiments already described in FIG. 7 and FIG. 8, and therefore will not be described here in greater detail.

FIG. 21 shows an exemplary embodiment according to the invention with six actuators A1 . . . A6 arranged inside the drive ring 1, symmetrically about the motor shaft axis 3 at an angular distance of 60 degrees.

In the embodiment of the motor according to the invention illustrated in FIG. 22, two drive rings 1, 1′ are fitted on a common rotor 2 with a motor shaft 3 connected in a rotationally engaged manner, wherein the drive ring 1 has actuators A1, A2, A3 associated therewith, and the drive ring 1′ has actuators A1′, A2′, A3′ associated therewith. The drive ring 1 has a torque support 9, and the drive ring 1′ has a torque support 9′. The torque supports 9, 9′ are attached between the respective drive ring 1, 1′ and the common motor housing 8. They enable displacement of the drive rings 1, 1′ in the xy plane arranged perpendicular to the motor shaft axis 3 and prevent rotational movements of the drive rings 1, 1′ about the motor shaft axis 3.

Any design of electromagnets can be used as actuators. The actuators each have the following components: motor housing 8, at least one electrically excitable effective element 4, 4′ with electrical feed lines 6, 6′, and a second effective element 5, 5′. The effective elements 4 and 5 and 4′ and 5′ are arranged at a distance from one another and are oriented such that they can exert magnetic forces onto one another along an effective axis 7, 7′. One of the effective elements of each actuator is fastened to the motor housing 8 (in FIG. 22 the effective elements 4 and 4′, whereas the effective element 5 is connected to the drive ring 1 and the effective element 5′ is connected to the drive ring 1′). In FIG. 22, the effective elements 5, 5′are identical to the drive ring 1, that is to say the drive ring comprises ferromagnetic material. The actuators A1, A2, A3 are in this case arranged over the periphery of the drive ring 1 at an angular distance of 120 degrees. The actuators A1′, A2′, A3′ are also arranged over the periphery of the drive ring 1′ at an angular distance of 120 degrees. The drive ring 1 with its drive elements A1, A2, A3 is rotated through 60 degrees in relation to the drive ring 1′ with its actuators A1′, A2′, A3′ and is axially offset in the z axis of the motor shaft 3 oriented perpendicular to the xy plane in FIG. 22. The drive ring 1 can be excited by its actuators A1, A2, A3 for circular displacement. The drive ring 1′ can also be excited by its drive elements A1′, A2′, A3′ for circular displacement. To rotate the rotor 2 and the motor shaft 3 connected thereto in a torque proof manner, the drive elements A1, A2, A3 and A1′, A2′, A3′ are actuated with the same radian frequency f with the same direction of rotation, wherein there is a phase shift between each of the actuators associated with a drive ring. The drive rings 1 and 1′ roll synchronously over the common rotor 2, whereby said rotor is rotated. The direction of rotation is reversed by commutating the phase relation of the electrical control signals.

It is particularly advantageous if the actuators A1, A2, A3 of the drive ring 1 are electrically actuated with an additional phase shift of 180 degrees in relation to the actuators A1′, A2′, A3′ of the drive ring 1′. As illustrated in FIG. 22 by the enlarged details F and F′, the contact areas between the drive ring 1 and drive ring 1′ thus revolve jointly in a diametrically opposed manner. The motor operated in this manner is completely mass-balanced and is characterised by a very high running smoothness and low vibration.

The exemplary embodiment shown in FIG. 22 with two drive rings is merely exemplary. The number of actively driven drive rings acting on a common rotor 2 is not limited, wherein each drive ring advantageously comprises a torque support. Power can be increased, and noise and vibration behaviour can be further improved by a greater number of drive rings.

FIG. 23 shows a sectional view of an embodiment according to design B.), in which the inner toothing 1.1 of the drive rotor 1 rolls over an outer toothing 2.1 of the motor housing 8 in the region 2. In this case, the element previously denoted as a torque support 9 takes over the function of a shaft coupling, which compensates for tilting motions and transverse displacement and transfers the output torques of the drive rotor 1 onto the motor shaft 3. To this end, the shaft coupling 9 is fastened directly between the drive rotor 1 and the motor shaft 3. The rotational motion of the drive rotor 1 is therefore transferred directly onto the motor shaft 3 via the shaft coupling 9 designed in this exemplary embodiment as a bellows. Actuators A1 . . . AX attached radially over the periphery of the motor housing 8 and comprising electromagnets 4.1, . . . 4.X, of which the common effective element is the ferromagnetic drive rotor 1, are used to excite the revolving displacement of the drive rotor 1. As a result of revolving phase-shifted current feed to the electromagnets 4.1 . . . 4.X, the drive rotor 1 is displaced cyclically in a circular manner and rolls into the toothing. The bellows acting as a shaft coupling has a high level of torsional rigidity, but is mechanically compliant to displacement in the plane perpendicular to its longitudinal axis. A second bellows (not illustrated in FIG. 23 for the sake of clarity) may optionally be arranged on the drive ring 1 opposite the bellows 9 and is mounted rotatably in the motor housing 8 at its end remote from the drive ring 1. In a further embodiment of this type of motor, the electromagnets may also be located inside the drive rotor. Electric motors of this design according to the invention are characterised by a very simple construction.

In most technical applications it is desirable for the drive shaft of the electric motor to carry out a purely rotational movement. Technical solutions in the form of the torque support and shaft coupling have been proposed for this purpose. If a rotational movement that is superposed by an oscillatory displacement (wobbling movement) of the motor shaft is permissible, FIG. 24 provides an even simpler solution for such an electric motor. FIG. 24 shows a sectional view. This electric motor according to the invention has a wobbling wheel 1 with an outer toothing 1.1, said wheel being connected to a motor shaft 3 in a torque proof manner. The motor housing 8 has an inner toothing 2.1 in the region 2 of the outer toothing 1.1 of the wobbling wheel 1. The toothings are designed such that the outer toothing 1.1 of the wobbling wheel 1 can roll into the inner toothing 2.1 in the region 2 of the motor housing 8. The wobbling wheel 1 has a smaller diameter than the inner diameter of the motor housing 8 in the region 2 for this purpose.

With the omission of any bearings, the wobbling wheel 1 is guided in a purely sliding manner by the parallel faces 8.1 and 8.2 of the motor housing 8. In FIG. 24 the sliding faces formed in such a way are denoted by G. The area of the sliding faces can be reduced by recesses 9 in the motor housing 8 or in the wobbling wheel 1, wherein the pockets thus formed can be used to receive lubricants. The wobbling wheel 1 is displaceable within the xy plane by the sliding bearing and can rotate about the z-axis of the motor shaft. A ring of ferromagnetic material or an annular permanent magnet is fastened at the outer radius of the wobbling wheel 1 as an electromagnetic effective element 5. Radially arranged electromagnets 4.1 to 4.x, which can exert magnetic forces onto the annular effective element 5, are located in recesses in the motor housing 8. The construction of the magnetic circuit is comparable to that shown in FIG. 21. Revolving magnetic forces are generated acting on the wobbling wheel 1 as a result of revolving phase-shifted current feed of the electromagnets 4.1 to 4.x, which leads to displacement of said wobbling wheel in a revolving manner and causes the outer toothing 1.1 of the wobbling wheel 1 to roll off into the inner toothing 2.1 of the motor housing 8. The motor shaft 3 is thus rotated, but the rotation is superposed by a wobbling displacement of the wobbling disk. For higher rotational speeds at lower torques, the electromagnets 4.1 to 4.x may also be arranged outside the effective element 5.

With regard to electromagnetic efficiency, embodiments of the electromagnets in the form of magnet poles P arranged in succession are very advantageous, as illustrated in FIG. 25. The magnetic flux F is closed over the ferromagnetic drive element 1 by feeding current in opposite directions to adjacent magnet poles P. A revolving magnetic force is achieved by phase-shifted actuation of the magnet poles P, whereby the drive element 1 is displaced cyclically in a circular manner and can roll over the drive ring, or the drive element itself is connected to the motor shaft via a torsionally rigid, yet shear-compliant torque support.

FIG. 26 shows a sectional plan view of an electromechanical motor with two electrostatic (comb) actuators denoted C1 and C2. The effective directions of the electrostatic actuators C1 and C2 are aligned with the midpoint of the drive element 1 and are oriented, at right angles to one another. Each of the at least two electrostatic actuators C1, C2 consists of a first effective element 5 with a comb-like electrode structure, which is connected fixedly to a substrate (not illustrated) or consists thereof, and of a second effective element 6 consisting of a second comb-like electrode structure attached movably in the effective direction of the respective electrostatic actuator C1 or C2 and which is connected to the drive element 1 via the strut-like structure acting as a torque support and consisting of the two struts 9.1 and 9.2. The first effective element 6 can be guided in parallel in the effective direction toward the second effective element 5 by means of a spring 7 attached to the movable effective element 6. The spring 7 likewise serves as a return element for the movable effective element 6. It is connected to the substrate in the region 8. When an electric voltage is applied between the effective elements 5 and 6, which are electrically isolated from one another, a force acts on them, as a result of which the movable effective element 6 is drawn into the fixed effective element 5. The movement of the movable effective element 6 directed toward the midpoint of the drive element 1 is transferred onto the drive element 1 by the struts 9.1 and 9.2. The struts 9.1, 9.2 are shear-compliant in relation to movements perpendicular to the longitudinal extension thereof. The movements of the respective effective elements of the electrostatic actuators C1 and C2 can thus be superposed in an undisturbed manner and transferred to the drive element 1. As a result of phase-shifted sinusoidal actuation of the two electrostatic (comb) drives C1 and C2, displacement of the drive element 1 can thus be generated. The drive element 1 has an inner toothing 1.1, which can roll into the outer toothing 2.1 of the rotor 2. The motor shaft 3 connected to the rotor 2 is thus rotated, and a pointer 4 for example may be fastened to said motor shaft.

The drive element 1 can be connected to a multiplicity of electrostatic actuators, wherein these can also be coupled mechanically to one another and oriented differently. The electrostatic motor according to the invention is therefore suitable for example for clocks or display instruments, or is suitable in the field of medical technology for metering systems, lab-on-chip applications and micropumps.

FIG. 27 shows the motor in a sectional view taken along line I-I′ in FIG. 26. The substrate 8, which is used as a base of a housing and may consist for example of silicon, glass, plastic or composite materials, has a cylindrical bore 10 to support the motor shaft 3. For passage of the motor shaft 3, the cover 12 has a bore 11. The distance between the cover 12 and base 8 is dimensioned such, that the drive element 1 and the rotor 3 can move freely in the plane spanned by the effective directions of the actuators C1 and C2. A pointer 4 for example can be attached to the motor shaft 3.

The electromechanical motor according to the invention can be operated both in a stepper motor mode and in a. continuous mode.

The motor principle presented is also functional with frictional force transfer between the drive ring and the rotor.

The motor according to the invention may have the following features in an advantageous embodiment:

Electromagnets and/or electrostatic actuators can be used as drive elements. Force can be introduced from the electromagnets into the drive ring or drive rotor via magnetic field forces and/or via electrostatic actuators via electric field forces. There is preferably no mechanical contact between the effective elements of the electromagnets and/or between the effective elements of the electrostatic actuators, since these are preferably separated from one another by an air gap. The electric motor according to the invention therefore has very good temperature behaviour. Assembly and adjustment are additionally simplified considerably, since narrow tolerances do not have to be observed.

Electromagnets are available on the market cost effectively in a wide range of designs and performance categories. Cost effective electric rotary drives of all performance categories can be produced with the electric motor according to the invention.

Electromagnets have a high level of operational stability over a wide temperature range and are not sensitive to moist atmospheres.

Electrostatic comb drives can be produced cost effectively in large numbers in batch manufacture.

The electric motor according to the invention can be formed with inwardly arranged or outwardly arranged actuators as well as with a non-rotational drive ring or a rotating drive rotor.

1. An electromechanical motor, comprising
a rotor, which is rotatable about an axis of rotation,
at least one drive element, which can be displaced so as to revolve about the axis of rotation such that the rotor is rotatable by displacement of the drive element,
at least two actuators, each with a first effective element, with which a force acting in one effective direction can be exerted onto a second effective element,
wherein the first and the corresponding second effective element are not interconnected,
and wherein the drive element can be displaced for rotation of the rotor as a result of the effect of the force of the at least two actuators.

2. The electromechanical motor according to the preceding claim, further having at least one torque support, which allows displacement of the drive element and prevents rotation of the drive element and preferably supports the drive element in a shear-compliant and torsionally rigid manner.

3. The electromechanical motor according to claim 1, characterised in that the drive element surrounds the rotor, or in that the rotor surrounds the drive element, or in that the drive element is connected to the rotor in a torsionally rigid manner and/or is connected to the rotor via at least one shaft coupling and/or is part of the rotor, wherein the drive element and/or the rotor is/are preferably circular or elliptical.

4. The electromechanical motor according to claim 1, characterised in that the rotor and the drive element each have a toothing, via which they engage in one another in regions, in that a force can be transferred at these areas of engagement from the drive element to the rotor for rotation of the rotor, wherein the inwardly arranged element formed of rotor and drive element preferably has a smaller number of teeth than the outwardly arranged element formed of rotor and toothing,
or in that the drive element and a region that is fixed in relation to a housing of the motor each have a toothing, via which they engage in one another in regions, such that a force can be exerted at these areas of engagement from the region that is fixed in relation to the housing onto the drive element for rotation of the rotor.

5. The electromechanical motor according to claim 1, characterised in that, for each of the actuators, one of the effective elements is connected fixedly to the drive element or is part of the drive element or is the drive element, and the other effective element is fixed in relation to the axis of rotation and/or a motor housing of the electromechanical motor.

6. The electromechanical motor according to claim 1, characterised in that the actuators are electromagnetic and/or electrostatic actuators.

7. The electromechanical motor according to claim 1, characterised in that at least one of the actuators or all of the actuators has/have an electromagnet as one of the effective elements and a magnetic or magnetisable element as the other of the effective elements, or
has/have a pot magnet as one of the effective elements and a magnetic or magnetisable element as the other of the effective elements, or
has/have a voice coil as one of the effective elements and a magnetic or magnetisable element as the other of the effective elements, into which the voice coil dips so that part of the magnetic or magnetisable element surrounds the voice coil about the coil axis thereof, and part of the magnetic or magnetisable element dips into the coil along its coil axis, or
has/have a linear or circular electromagnet or a lifting magnet as one of the effective elements and a magnetic or magnetisable element as the other effective element.

8. The electromechanical motor according to claim 1, characterised in that there is a gap between each of the effective elements of the actuators, the distance between the two effective elements preferably being ≦2 mm, more preferably ≦1 mm, and more preferably ≦0.5 mm wide.

9. The electromechanical motor according to claim 1, characterised in that the at least two actuators each have two of the first effective elements, with which the force can be exerted onto the corresponding second effective element in an opposite direction, wherein the force of the two first effective elements can preferably be exerted onto the second effective element with a phase shift of 180° to one another.

10. The electromechanical motor according to claim 1, characterised in that, for each of the at least one drive elements, N actuators are provided, of which the effective directions lie in a common plane, wherein the effective directions of adjacent actuators of the same drive element are arranged relative to one another at an angle α of α=±360°/N for N≧3 and α=±90° for N=2, wherein, to generate the force, an alternating current and/or an alternating voltage can be applied to the actuators, said alternating current and/or voltage being phase-shifted for adjacent actuators by the corresponding angle α in each case, and wherein, for all actuators, α preferably has the same algebraic sign for actuators adjacent in the same direction.

11. The electromechanical motor according to claim 1, characterised in that, for each of the at least one drive elements, an even number N of actuators is provided and the effective directions of actuators of the same drive element that are mutually opposed with respect to the axis of rotation are directed parallel to one another in the same direction.

12. The electromechanical motor according to claim 1, characterised in that the effective directions are directed in the direction of the axis of rotation or are directed at an angle <0° with their point of action to the radius.

13. The electromechanical motor according to claim 2, characterised in that the torque support has at least one hose-shaped bellows with two edges, or is such a bellows that it is arranged fixedly on the drive element by one of the edges and is fixed in relation to the axis of rotation and/or the motor housing via the other edge,
or in that the torque support has, or is, at least one solid state hinge connecting two arms, said solid state hinge being arranged fixedly on the drive element by one of the arms and being fixed in relation to the axis of rotation and/or the motor housing by the other arm,
or in that the torque support has at least one spring, which is arranged fixedly on the drive element via one end and is fixed via the other end with respect to the axis of rotation and/or the motor housing, or
in that the torque support has two springs, which are arranged opposite two of the actuators with respect to the axis of rotation, such that they exert a resilience spring force onto the drive element opposing the force of the corresponding actuator, wherein the springs are preferably slotted spring metal sheets.

14. The electromechanical motor according to claim 2, characterised in that the torque support has two arms, which each have bars interconnected via a hinge and preferably arranged substantially at right angles to one another,
wherein, in each case, one end of the respective arm is connected fixedly to the drive element and the other end is fixed with respect to the axis of rotation, further having a strut of high tensile and compressive strength, which braces together the hinges of the two arms at a fixed distance.

15. The electromechanical motor according to claim 2, characterised in that the torque support has at least two, three or four bolts that are fixed relative to the axis of rotation and/or the motor housing, said bolts dipping into recesses in the drive element, said recesses being arranged substantially perpendicular to a plane of the displacement of the drive element, wherein the bolts preferably dip into a sliding block guide arranged in the recess in the drive element, said sliding block guide having a displacement element, which has an inner recess extending in a first direction parallel to the plane of the displacement of the drive element and into which the corresponding bolt dips, and said displacement element being guided movably in a recess in the drive element in a direction perpendicular to the first direction, or
wherein the bolts each dip into a recess in an eccentric eye arranged in a circular recess in the drive element, wherein the recess in the circular eccentric eye is arranged aside of a midpoint of the eccentric eye.

16. The electromechanical motor according to claim 1, characterised in that at least two drive elements are provided, which can be displaced so as to revolve around the axis of rotation such that the rotor is rotatable by displacement of the drive elements, wherein, during the displacement, the drive elements preferably contact the rotor in different regions for displacement, said regions being distanced from one another by an angle β=360°/M about the axis of rotation, wherein M is the number of drive elements.

17. The electromechanical motor according to claim 1, further comprising an evaluation unit, with which changes to the position of the actuators and/or to forces acting on the actuators can be established, preferably via an inductance of the respective actuators, and a load acting on the rotor can be established from these changes of position and/or changes of force.

18. The electromechanical motor according to claim 1, characterised in that said motor is formed as a microelectromechanical system (MEMS).
